(19) United States
(12) Patent Application Publication
(10) Pub. No.: US 2009/0213464 A1
(43) Pub. Date: Aug. 27, 2009

(54) Light polarizing sheet and manufacturing method for same

(76) Inventors: Yoshiya Kurachi, Kanagawa (JP); Tetsuya Suda, Kanagawa (JP); Masae Ono, Kanagawa (JP); Masatoshi Toda, Kanagawa (JP); Haruko Ootsuki, Kanagawa (JP); Kazumi Mizuhara, Kanagawa (JP); Tomonari Yoshimura, Kanagawa (JP)

Correspondence Address: MORGAN LEWIS & BOCKIUS LLP, 1111 PENNSYLVANIA AVENUE NW, WASHINGTON, DC, 20004, US

(21) Appl. No.: 11/991,183

(22) PCT Filed: Aug. 30, 2006
(86) PCT No.: PCT/JP2006/317128

§ 371 Date: Feb. 17, 2009

(30) Foreign Application Priority Data
Aug. 30, 2005 (JP) 2005-249521
Aug. 3, 2006 (JP) 2006-212172

(51) Int. Cl. G02B 5/02; G02F 1/13357; B29D 11/00

(52) U.S. Cl. 359/599; 349/65; 156/308.4

(57) ABSTRACT

Provides a light polarizing sheet which is easy to manufacture, offers the functionality of conventional multiple sheet structures, and satisfies both the luminance and viewing angle characteristics required for liquid crystal televisions and the like.

The light polarizing sheet of the present invention comprises a first polarizing lens sheet including a sheet-shaped substrate and a first lens portion formed on one face of the substrate; and a second polarizing lens sheet including a sheet-shaped substrate and a second lens portion formed on one face of the substrate, having a flat portion on its tip; wherein the flat portion of the second lens portion on the second polarizing lens sheet and the other face of the substrate of the first polarizing lens sheet are adhered using a transparent material.

### TECHNICAL FIELD

The present invention relates to a light polarizing sheet for a surface light source device, and more particularly to a light polarizing sheet used in a direct backlight surface light source device.

### BACKGROUND ART

Known backlights for illuminating display panels such as liquid crystal displays and the like include direct backlights in which a light source comprising an array of multiple cold cathode fluorescent lamps (CCFLs) or light emitting diodes (LEDs) is disposed directly beneath a liquid crystal display panel. In such direct backlights, light from the light source device must be diffused and polarized to illuminate the liquid crystal display panel uniformly.

In conventional backlights, therefore, light from the light source was diffused and polarized to uniformly illuminate the liquid crystal display by sequentially disposing, starting from the light source side, a diffusion sheet, a diffusion film, and a prism sheet.

The diffusion sheet has the function of blurring the light source image and making luminance uniform. The diffusion film also has the function of making luminance uniform. The prism sheet has the function of directing light aimed in the light source direction upward (in the light exiting direction), and of controlling the viewing angle by polarizing light exiting from the diffusion film.

Such diffusion sheets, diffusion films, and prism sheets are supplied and laminated as separate sheets, making it necessary to punch through and process each one separately. This raises the cost of backlights and decreases backlight yield due to the mixing in of dust during assembly; each film must also be made thicker to prevent thermal distortion, thus causing additional problems such as increased backlight weight and the like.

Light polarizing sheets and light collecting light diffusion panels capable of diffusing and polarizing light from a light source in a single sheet have therefore been proposed (see Patent Document 1, Patent Document 2, Patent Document 3, and Patent Document 4).

Patent Document 1 JP Unexamined Publication No. 08-184704

Patent Document 2 JP Unexamined Publication No. 10-48430

Patent Document 3 U.S. Pat. No. 6,846,089

Patent Document 4 JP Unexamined Publication No. 2005-99803

### DISCLOSURE OF THE INVENTION

### Problems to be Solved by the Invention

However, the light polarizing sheet in Patent Document 1 has the problem that the process by which fine particles are diffused, dispersed, and dried is complex. The light gathering light diffusion panel of Patent Document 2 has the problem that integrating the sheet materials forming its constituent parts into a single piece is difficult.

The optical sheet in Patent Document 3, in which prism sheets with a peak angle of 90° are laminated (or adhered) together, has difficulty obtaining a wide viewing angle.

The optical sheet of Patent Document 4 has problems with adhesion properties when integrated into a single piece, as well as the occurrence of unevenness in the gaps where no fusion occurs between protuberance spacing structures due to expansion or stretching and shrinking caused by temperature changes, making it difficult to obtain uniform optical properties.

The present invention was undertaken to solve such problems, and has the object of providing a light polarizing sheet which is easy to manufacture, offers the functionality of conventional multiple sheet structures, and satisfies both the luminance and viewing angle properties required for liquid crystal televisions and the like.

### Means for Solving the Problems

The present invention provides a light polarizing sheet comprising;

a first polarizing lens sheet including a sheet-shaped substrate and a first lens portion formed on one side of the substrate;

and a second polarizing lens sheet including a sheet-shaped substrate and a second lens portion formed on one side of the substrate and having a flat portion on its tip;

wherein the flat portion on the second lens portion in the second polarizing lens sheet and the other side of the substrate of the first polarizing lens sheet are adhered using a transparent material.

In another preferred embodiment of the present invention, the transparent material comprises an ionizing radiation curable resin which remains tacky after curing.

In another preferred embodiment of the present invention, the transparent material is disposed on a portion of the flat portion.

In another aspect, the present invention provides 1 light polarizing sheet comprising;

a first polarizing lens sheet including a sheet-shaped substrate and a lens portion formed on one side of the substrate;

and a second polarizing lens sheet including a sheet-shaped substrate and a lens portion formed on one side of the substrate;

wherein the first polarizing lens sheet is disposed such that the lens portion of the first polarizing lens sheet opposes the other side of the second polarizing lens sheet substrate, and an ionizing radiation curable resin or tacky particles are provided into a gap between the first and the second polarizing lens sheets.

In another preferred embodiment of the present invention, the index of refraction of the ionizing radiation curable resin is set to be not less than 0.05 below the index of refraction of the second polarizing lens sheet.

In another aspect, the present invention provides a light polarizing sheet comprising;

a first polarizing lens sheet including a sheet-shaped substrate and a lens portion formed on one side of the substrate;

a diffusion sheet disposed facing to the other side of the light polarizing sheet; and

a second lens portion made of plastic, disposed on the surface of the diffusion sheet opposing the light polarizing sheet;

whereby a resin with an index of refraction of not less than 0.05 greater than the resin forming the second lens portion is provided in between the other side of the substrate and the second lens portion.

In another preferred embodiment of the present invention, the first lens portion comprises a plurality of columnar prisms, triangular in cross section and arrayed in parallel; the second lens portion comprises a plurality of columnar lenses, circular in cross section and arrayed in parallel; and the columnar lenses are disposed to extend at a right angle to the columnar prisms.

In another aspect, the present invention provides a light polarizing sheet comprising;

a polarizing lens sheet including a sheet-shaped substrate and a lens portion formed on one side of the substrate;

a protruding structure disposed such that one end thereof contacts another side of the substrate;

and a diffusion sheet supported by the other end of the protruding structure so as to oppose the other side of the substrate.

In another preferred embodiment of the present invention, the other end of the protruding structure is adhered to the diffusion sheet using transparent material.

In another preferred embodiment of the present invention, the first lens portion is a columnar prism, triangular in section, wherein the peak angle of the columnar prism portion is not less than 60° and not greater than 150°.

In another preferred embodiment of the present invention, the second lens portion is a columnar prism portion having the sectional shape of a truncated triangle, wherein the peak angle of the triangle is not less than 60° and not greater than 150°.

In another aspect, the present invention provides a light polarizing sheet comprising;

a polarizing lens sheet including a sheet-shaped substrate and a lens portion formed on one side of the substrate;

and a diffusion sheet disposed facing to the other side of the substrate of the polarizing lens sheet;

whereby the diffusion sheet is disposed apart from the other side of the polarizing lens sheet using a transparent ionizing radiation curable resin portion discretely disposed between the other side of the polarizing lens sheet substrate and the diffusion sheet.

In another aspect, the present invention provides alight polarizing sheet comprising;

a first polarizing lens sheet including a sheet-shaped substrate and a first lens portion comprising triangular columnar prisms disposed in parallel on each other on one side of the substrate;

and a second polarizing lens sheet including a sheet-shaped substrate and a second lens portion comprising triangular columnar prisms disposed in parallel on each other on one side of the substrate;

whereby the first polarizing lens sheet and the second polarizing lens sheet are disposed such that the first lens portion extends perpendicular to the second lens portion and, by burying the tip of the first polarizing lens sheet first lens portion, the first polarizing lens sheet and the second polarizing lens sheet are integrated into a single piece, with a transparent material tacky layer provided on a side opposite the second polarizing lens sheet substrate second lens portion,

such that if X is the peak angle of the lens portion controlling the horizontal viewing direction within the first lens portion and the second lens portion, and Y is the peak angle of the lens portion controlling the vertical viewing direction within the first lens portion and the second lens portion, Formulas (1) through (3) below are satisfied:

70°≦X≦150° Formula (1)

70°≦Y≦130° Formula (2)

195°≦X+Y≦225° Formula (3)

In another aspect, the present invention provides a method for manufacturing a light polarizing sheet comprising a first polarizing lens sheet including a sheet-shaped substrate and a first lens portion formed on one side of the substrate, and a second polarizing lens sheet including a sheet-shaped substrate and a second lens portion having a flat portion on a tip and formed on one side of the substrate, whereby the flat portion of the first polarizing lens sheet lens portion and the other side of the second polarizing lens sheet substrate are adhered together using a transparent material, the method comprising steps of;

forming a tacky layer by transparent material on the other side of a first polarizing lens sheet substrate, on the flat portion of a second polarizing lens sheet second lens portion, or on the other side of the first polarizing lens sheet substrate and the flat portion of the second lens portion on the second polarizing lens sheet and

adhering the flat portion of the second lens portion of the second polarizing lens sheet to the other side of the substrate of the first polarizing lens sheet.

In another aspect, the present invention provides a method for manufacturing a light polarizing sheet comprising a polarizing lens sheet including a sheet-shaped substrate and a first lens portion formed on one side of the substrate, a protuberance structure linked at one end to the other side of the substrate, and a diffusion sheet supported on the other end of the protuberance structure and disposed so as to face to the other side of the substrate, the method comprising the steps of

forming at the other end of the protuberance structure a transparent material tacky layer which retains tackiness after curing;

and pressing the diffusion sheet onto the other end of the protuberance structure and adhering the polarizing lens sheet and the diffusion sheet.

In another aspect, the present invention provides a method for manufacturing a light polarizing sheet comprising a diffusion sheet and a polarizing lens sheet having a sheet-shaped substrate and a lens portion formed on one side of the substrate, the method comprising steps of;

coating a transparent material which retains tackiness after curing onto the other side of the substrate of the polarizing lens sheet in a dotted or striped pattern and

superimposing the other side of the polarizing lens sheet substrate and one side of the diffusion sheet to adhere together the polarizing lens sheet and the diffusion sheet.

### EFFECT OF THE INVENTION

The present invention provides a light polarizing sheet which is easy to manufacture, offers the functionality of conventional multiple sheet structures, and satisfies both the luminance and the viewing angle properties required for liquid crystal televisions or the like.

### DESCRIPTION OF THE PREFERRED EMBODIMENT

Below we discuss embodiments of the present invention in detail with reference to the attached drawings. First we discuss a light polarizing sheet 10 in a first embodiment of the present invention. FIG. 1(a) is a schematic cross sectional view of the light polarizing sheet 10 of the embodiment; FIG. 1(a) is a schematic cross sectional view along line b-b in FIG. 1(a). FIG. 2 is a schematic cross sectional view showing the light polarizing sheet 10 assembled into a liquid crystal display device backlight.

The light polarizing sheet 10 integrates a diffusion film and a prism sheet used in a conventional direct backlight system. As depicted in FIG. 2, the light polarizing sheet 10 is disposed between a plurality of cold cathode tubes or other such linear light sources 4, and a liquid crystal display panel 6 within a backlight 2; and has the function of diffusing and polarizing light emitted from the linear light source 4 together with the diffusion sheet 8, thereby uniformly illuminating the liquid crystal display panel.

The light polarizing sheet 10, as shown in FIG. 1, comprises a first sheet isotropic lens sheet 14 and a second sheet prism sheet 12.

The prism sheet 12 comprises a flat sheet-shaped substrate portion 16 and a plurality of columnar prism portions 18 disposed in parallel on one side (the front side) of the substrate portion 16. The columnar prism 18, trapezoidal in cross section, has at its peak a flat portion 18a parallel to its base surface. The trapezoid preferably has a shape with a cut off triangular peak (truncated triangle shape), wherein the peak angle of the triangle is not less than 60° and not greater than 150°. The substrate portion 16 and the columnar prism portion 18 are formed of transparent material.

The substrate portion 16 is preferably formed of a transparent resin film such as (meta) acrylic resin, polycarbonate resin, PET resin, polystyrene resin, polystyrene resin, AS resin (acrylonitrile styrene copolymer resin), or polyolefin resin. A light diffusing film containing an inorganic or organic (polymer bead) dispersion agent may also be used.

The columnar prism portion 18 is also preferably formed from an active energy ray curing material such as a (meta) acrylate active energy ray curing composition. Examples of a (meta) acrylate active energy ray curing composition include acrylate resins such as polyester (meta) acrylate, epoxy (meta) acrylate, and urethane (meta) acrylate.

The columnar prism portion 18 preferably has a thickness of approximately 5-500 μm and a pitch of approximately 5-500 μm. Pitch is preferably 10-100 μm, and more preferably 10-50 μm.

In lieu of the columnar prism portion 18, a bumpy shape, a lenticular lens approximately semicircular or semi-elliptical in section, or a waveform-shaped lens surface shape may be used to form in the aggregate a Fresnel. The same types or dimensions of shape may be disposed, as may shapes of different types or dimension.

In the present embodiment, the width of the flat portion 18a is set to be less than 10% of the columnar prism portion 18 array pitch so as to control the diminution of luminance of light diffused and polarized by the light polarizing sheet 10. For example, in a configuration in which 90° peak angle columnar prisms 18 are arrayed at a pitch of 50 μm, the diminution of luminance in the normal direction is approximately 5% when the width of the flat portion 18a is set at approximately 5 μm.

The isotropic lens sheet 14 comprises a flat sheet-shaped substrate portion 20 of transparent material, and multiple particles 22. The particles 22 are arrayed without voids on the entirety of one side (the front side) of the substrate portion 20, and are adhered to one side (the front side) of the substrate portion 20 using a transparent binder 24.

The substrate portion 20 should be formed of a transparent resin film such as (meta) acrylic resin, polycarbonate resin, PET resin, polystyrene resin, AS resin (acrylonitrile styrene copolymer resin), polyolefin resin or the like. A light diffusing film containing an inorganic or organic (polymer bead) diffusion agent may also be used.

The particles 22 are preferably formed of (meta) acrylic resin, MS resin (methacryl styrene copolymer resin), polystyrene resin, silicon resin, urethane resin, epoxy resin, polyolefin resin, benzoguanamine-melamine-formaldehyde resin or the like. In the present embodiment, the particles 22 are spherical in shape, but they may also have other shapes, for example an elliptical shape (football shape).

In the present embodiment, the diameters of the particles 22 have a broad particle diameter distribution with respect to peak particle diameter. However, even if the particles 22 comprise particles with random and multiple diameters, they may also comprise particles using a single or multiple monodispersion particle diameters (a sharp particle diameter distribution).

In order to avoid problems such as coloration, moiré bands, and sticking (adhesion) between particles caused by scattering and reflection at particular wavelengths, it is preferable for the diameter of the particles 22 to be broadly distributed or random.

The isotropic lens sheet 14 has the function of adjusting the viewing angle. Since a diffusion function is not required of the isotropic lens sheet 14, the index of refraction n of the particles 22 and the binder 24 is approximately equal, and is set, for example, at approximately 1.5.

In the light polarizing sheet 10 of the present embodiment, the flat portion 18a of the columnar prism portion 18 on the prism sheet 12 is adhered to the other side (the reverse side) of the isotropic lens sheet 14 substrate portion 20 using a tacking agent (not shown), such that the prism sheet 12 becomes integrated with the isotropic lens sheet 14. Note that the tacking agent is transparent, with approximately the same index of refraction as the resin which constituting the columnar prism portion 18.

An acrylic, urethane, polyester, epoxy, silicon, or other tacking agent or adhesive is used as the tacking agent. Examples of such tacking agents or adhesives include hot melt, solvent, and reacting-type materials (ionization radiation curing using thermal curing, UV, or electron beams, etc.).

A tacking agent which retains stickiness after curing is more preferable, since it enables post-curing deformation of the tacking agent caused by the pressure of lamination to be prevented and post-curing optical characteristic stability to be preserved without an overflow of the tacking agent onto the sloped surface of the tip of the prism upon lamination, such that the tip portion is submerged in the tacking agent.

Furthermore, a transparent resin formed of ionizationizing radiation curable resin with post-curing stickiness is preferred. This is because tacking agents cured using ionization radiation such as UV rays or electron beams are capable of suppressing the diffusion of volatile substances as well as enabling the simplification of manufacturing lines due to the compact size of devices emitting UV rays or electron beams.

Next we discuss a second embodiment light polarizing sheet 25 of the present invention. FIG. 3(a) is a schematic cross sectional view of the light polarizing sheet 25 of the present embodiment; FIG. (b) is a schematic cross sectional view along line b-b of FIG. 3(a).

As in the first embodiment light polarizing sheet 10, the light polarizing sheet 25 is a light polarizing sheet integrating a diffusion film and a prism into a single piece.

As shown in FIG. 3, the light polarizing sheet 25 of the present embodiment has a structure in which the prism sheet 26 constituting a first sheet and the cross prism sheet 28 constituting a second sheet are laminated (or adhered) together.

The prism sheet 26 comprises a flat sheet-shaped substrate portion 30 and a plurality of columnar prism portions 32 disposed in parallel on one side (the front side) of the substrate portion 30. The substrate portion 30 and the columnar prism portions 32 are constituted of transparent material. The columnar prism portions 32 consist of a plurality of columnar prisms, triangular in cross section and arrayed in parallel, and primarily serve to adjust the vertical direction viewing angle. The columnar prism portions 32 peak angle is preferably within a range of 60°-150°; in the present embodiment it is set at 90°.

The substrate portion 30 and the columnar prism portions 32 are respectively formed from a material similar to that of the light polarizing sheet substrate portion and the columnar prism portion in the first embodiment.

Next we discuss the configuration of the cross prism sheet 28. FIG. 4(a) is a plan view of a portion of the cross prism sheet 28; FIG. 4(b) is a schematic cross sectional view along line b-b in FIG. 4(a); FIG. 4(c) is a schematic cross sectional view along line c-c in FIG. 4(a); FIG. 4(d) is a schematic cross sectional view along line d-d in FIG. 4(a); and FIG. 4(e) is a schematic cross sectional view along line e-e in FIG. 4(a).

As shown in FIG. 3, the cross prism sheet 28 comprises a flat sheet-shaped substrate portion 33 and a prism portion 34 disposed on one side of the substrate portion 33. As shown in FIGS. 3 and 4, the prism portion 34 is a one in which the lateral direction (the horizontal direction on the screen) prism peak angle is 120° and the vertical (the vertical direction on the screen) prism peak angle is 110°.

In the cross prism sheet 28 of the present embodiment, a flat portion 32a is formed at the end of the axis extending in the vertical direction (the vertical direction on the screen).

The substrate portion 33 and the prism portion 34 are respectively formed of a similar material to the first embodiment light polarizing sheet substrate portion and the columnar prism.

In the cross prism sheet 28 of the present embodiment, the prism pitch ratio of the prism portion horizontal direction to the vertical direction is 1:3. Put another way, if the prism pitch in the same direction X as the direction in which the columnar prism portions 32 extend on the prism sheet 26 is 1, setting is made so that the pitch in the direction Y perpendicular to the direction in which the prism sheet 26 columnar prism portions 32 extend will be 3. In the present embodiment, the pitch in the horizontal direction is set to 35 μm, and the pitch in the vertical direction is set to 105 μm.

In the prism sheet 26, the prism portion 34 flat portion 32a is adhered using a tacking agent (not shown) to the other side (the reverse side) of the substrate portion 30, thereby forming a single piece with the prism sheet 26. Note that the tacking agent is a transparent tacking agent with approximately the same index of refraction as the resin constituting the prism portion 34.

A cross prism sheet of the type shown in FIGS. 5 and 6 may also be used in lieu of the cross prism sheet 28.

FIG. 5(a) is a schematic plan view showing a portion of an alternative example cross prism sheet 36; FIG. 5(c) is a schematic cross sectional view along line b-b; and FIG. 5(c) is schematic cross sectional view along line c-c. As shown in FIG. 5, the cross prism sheet 36 comprises a flat sheet-shaped substrate 38 and a prism portion 40 disposed on one side (the front side) of the substrate 38. The prism portion 40 is formed by disposing approximately square pyramid-shaped very small prisms 42 with rectangular base surfaces on the surface of the substrate 38. A flat portion 42a parallel to the base surface is formed at the tip of each of the prisms 42. The cross prism sheet 36 can be manufactured by fabricating a reverse mold using electrocasting, for example, then using this reverse mold as a mold.

In the present embodiment, the flat portion 42a is adhered to the other side (the front side) of the substrate portion 30 using a tacking agent (not shown), and the cross prism sheet 36 is integrated as a single piece with the prism sheet 26.

FIG. 6(a) is a schematic plan view showing a portion of a cross prism sheet 44 in another alternative example; FIG. 6(b) is a schematic cross sectional view along line b-b in FIG. 6(a); FIG. 6(c) is a schematic cross sectional view along line c-c in FIG. 6(a); FIG. 6(d) is a schematic cross sectional view along line d-d in FIG. 6(a); and FIG. 6(e) is a schematic cross sectional view along line e-e in FIG. 6(a).

As shown in FIG. 6, the cross prism sheet 44 comprises a flat sheet-shaped substrate portion 46 and a prism portion 48 disposed on one side of the substrate portion 46. The cross prism sheet 44 comprises a flat portion 48a at the tip of an axis extending in the lateral direction (horizontally on the screen).

This flat portion 48a is adhered to the other side (the reverse side) of the prism sheet substrate portion using a tacking agent (not shown), so that the cross prism sheet 44 and the prism sheet are integrated as a single piece.

In the light polarizing sheet of the present embodiment, moiré fringes can occur when the prism portions of each sheet are disposed in parallel between laminated (or adhered) sheets. To prevent such moiré fringes, it is preferable either to randomize the pitch at which prisms are arrayed on one of the sheets, or to set the pitch at which prisms are arrayed on one of the sheets to be from (N+0.4) to (N+0.6) (where N is an integer) times the pitch at which prisms are arrayed on the other sheet.

A cross-wrench-shaped cross prism sheet such as that shown in FIGS. 7 and 8 can also be used in place of the cross prism sheet 28.

FIG. 7(a) is a plan view showing a portion of an alternative example cross prism sheet 50; FIG. 7(b) is a schematic cross sectional view along line b-b in FIG. 7(a); FIG. 7(c) is a schematic cross sectional view along line c-c in FIG. 7(a); FIG. 7(d) is a schematic cross sectional view along line d-d in FIG. 7(a); and FIG. 7(e) is a schematic cross sectional view along line e-e in FIG. 7(a).

As shown in FIG. 7, the cross prism sheet 50 comprises a flat sheet-shaped substrate portion 52 and a prism portion 54 disposed on one side of the substrate portion 52. A flat portion 54a extending in the lateral direction (the horizontal direction on the screen) is formed on the tip of the cross prism sheet 50 prism portion 54.

This flat portion 48a is adhered to the other side (the reverse side) of the prism sheet substrate portion using a tacking agent (not shown), so that the cross prism sheet 44 is integrated with the prism sheet as a single piece.

FIG. 8(a) is a plan view showing part of an alternative example cross prism sheet 56; FIG. 8(b) is a schematic cross sectional view along line b-b in FIG. 8(a); FIG. 8(c) is a schematic cross sectional view along line c-c in FIG. 8(a); FIG. 8(d) is a schematic cross sectional view along line d-d in FIG. 8(a); and FIG. 8(e) is a schematic cross sectional view along line e-e in FIG. 8(a).

As shown in FIG. 8, the cross prism sheet 56 comprises a flat sheet-shaped substrate portion 58 and a prism portion 60 disposed on one side of the substrate portion 58. A flat portion 60a extending vertically (in the vertical direction on the screen) is formed on the tip of the cross prism sheet 60 prism portion 56.

The flat portion 60a is adhered to the other side (the reverse side) of the prism sheet substrate portion using a tacking agent (not shown), so that the cross prism sheet 56 is integrated with the prism sheet as a single piece.

Next we discuss a third embodiment light polarizing sheet 62. FIG. 9(a) is a schematic cross sectional view of the light polarizing sheet 62 of this embodiment; FIG. 9(b) is a schematic cross sectional view along line b-b of FIG. 9(a).

As shown in FIG. 9, the light polarizing sheet 62 of the present embodiment comprises laminated first and second prism sheets 64 and 66.

The first prism sheet 64 comprises a flat sheet-shaped substrate portion 68 and a plurality of columnar prism portions 70 disposed in parallel on one side (the front side) of the substrate portion 68.

The peak angle of the columnar prism portions 70 is preferably in a range of 60-150°. The substrate portion 68 and the columnar prism portions 70 are formed of the same type of transparent material as in the first embodiment above.

The second prism sheet 66 also comprises a flat sheet-shaped substrate portion 72 and a plurality of columnar prism portions 74 disposed in parallel on one side (the front side) of the substrate portion 72. A second prism sheet 66 columnar prism portion 74 has a trapezoidal cross sectional shape at the tip of which a flat portion 74a is formed parallel to the base surface thereof. This trapezoid has the shape of a triangle from which the peak portion is cut off, with a peak angle of no less than 60° and no greater than 150°. The light polarizing sheet 62 and the columnar prism portion 74 are formed of the same type of transparent material as in the first embodiment above.

The first prism sheet 64 and the second prism sheet 66 are disposed such that the columnar prism portions 70 and 74 extend perpendicularly to one another. The second prism sheet 66 flat portion 74a is adhered to the reverse surface of the first prism sheet 64 substrate portion 68 using a tacking agent (not shown), integrating the first prism sheet 64 and the second prism sheet 66 as a single piece.

High luminance and broad viewing angle are required for liquid crystal television and the like, therefore in such applications it is preferable to adjust the peak angle of each prism portion to obtain the viewing angle required of each display.

In light polarization by a prism sheet, luminance and viewing angle characteristics are inversely related. For example, when the light emission angular range (viewing angle) in a prism is narrowed, which is to say when diffused light rays are polarized (focused) within a narrow angle by a prism, the luminance of light emitted from a diffusion panel in the backlight normal direction increases. Conversely, when the angle of light emission from a prism (the viewing angle) is broadened, the focusing effect in the normal direction is diminished, and luminance in the normal direction is reduced.

Assuming a peak angle for the columnar prism portion controlling the horizontal viewing direction of X, and a peak angle for the columnar prism portion controlling the horizontal viewing direction of Y, the triangle cross section peak angles in the columnar prism portions 70 and the columnar prism portion 74 should satisfy the following Formulas (1) through (3).

70°≦X≦150° Formula (1)

70°≦Y≦130° Formula (2)

195°≦X+Y≦225° Formula (3)

With a light polarizing sheet satisfying the conditions from Formulas (1) through (3) above, luminance peaks emitted from the diagonal direction with respect to the backlight normal direction referred to as the “side lobe” are suppressed, and a reduction can be made in the light and dark variations of the backlight caused by the angle at which the backlight is observed when the viewing angle is changed.

It is further preferable that the peak angle X and the peak angle Y satisfy the following Formula (4) through (6):

90°≦X≦140° Formula (4)

80°≦Y≦120° Formula (5)

200°≦X+Y≦240° Formula (6)

A light polarizing sheet which satisfies these conditions is capable of providing both high luminance and good viewing angle.

In a light polarizing sheet in which the peak angle X of the prism sheet controlling the horizontal viewing direction is disposed on the lower side (the first light polarizing sheet) and the peak angle Y of the prism sheet controlling the vertical viewing direction is disposed on the lower side (the second light polarizing sheet), and Formula (7) is satisfied in addition to Formulas (4) through (6), a higher luminance and viewing angle can be achieved.

X≧Y Formula (7)

Next we discuss a fourth embodiment light polarizing sheet 400 of the present invention.

FIG. 10(a) is a schematic plan view of a light polarizing sheet 400 seen through a tacky layer 402 which adheres together the two prism sheets of the light polarizing sheet 400. FIG. 10(b) is a schematic cross sectional view along line a-a in FIG. 10(a); FIG. (c) is a schematic cross sectional view along line c-c in FIG. 10(a).

As shown in FIG. 10, the light polarizing sheet 400 comprises a first prism sheet 404 and a second prism sheet 406.

The first prism sheet 404 comprises a flat sheet-shaped substrate portion 408 and a plurality of columnar prism portions 410 triangular in cross section and disposed in parallel on one side (the front side) of the substrate portion 408. The substrate portion 408 and the columnar prism portion 410 are composed of the same type of transparent material as in the first embodiment above.

The second prism sheet 406 also comprises a flat sheet-shaped substrate portion 412 and a plurality of columnar prism portions 414 disposed in parallel on one side (the front side) of the substrate portion 412. The second prism sheet 406 columnar prism portion 414 has a trapezoidal cross sectional shape at the tip of which a flat portion 414a is formed parallel to the base surface thereof. The substrate portion 412 and the columnar prism portion 414 are composed of the same type of transparent material as in the first embodiment above.

The first prism sheet 404 and the second prism sheet 406 are disposed in such a way that the columnar prism portions 410 and 414 extend perpendicularly to one another.

A tacky layer 402 composed of transparent resin is provided on the other side (the reverse side) of the first prism sheet 404 substrate portion 408. The tacky layer 402 comprises a tacking agent or adhesive, and is disposed in a striped pattern having an angle of inclination of 45° with respect to the mutually perpendicular columnar prism portions 410 and 414.

The first prism sheet 404 and the second prism sheet 406 are laminated (or adhered) into a single piece in the part at which the second prism sheet 406 columnar prism portion 414 flat portion 414a contacts the tacky layer 402 provided on the reverse side of the first prism sheet 404. In other words, the tacky layer 402 is disposed to cover a portion of the columnar prism portion 414 flat portion 414a.

In the fourth embodiment, the tacky layer 402 is assumed to have a striped pattern, but the tacky layer pattern may be any pattern so long as a portion of the flat portion 414a at the tip of the columnar prism portion 414 is joined thereto; for example, a dot pattern would be acceptable. The tacky layer 192 pattern may be either a regular or a random pattern.

From the standpoint of sealing strength between the first and second prism sheets 404 and 406, the surface area of the connecting portion between the tacky layer 402 and the columnar prism portion 414 is preferably 25-99% of the surface area of the flat portion 414a, and more preferably 50%-99% thereof.

Next we discuss a fifth embodiment light polarizing sheet 76. FIG. 11(a) is a schematic cross sectional view of the light polarizing sheet 76 of the present embodiment; FIG. 11(b) is a schematic cross sectional view along line b-b in FIG. 11(a).

As shown in FIG. 11, the light polarizing sheet 76 of the present embodiment also comprises laminated first and second prism sheets 78 and 80.

The first prism sheet 78 also comprises a flat sheet-shaped substrate portion 82 and a plurality of columnar prism portions 84, triangular in cross section and disposed in parallel on one side (the front side) of the substrate portion 82. The peak angle of the columnar prism portion 84 is preferably in a range from 60-150°. The substrate portion 82 and the columnar prism portion 84 are composed of the same type of transparent material as in the first embodiment above.

The second prism sheet 80 also comprises a flat sheet-shaped substrate portion 86 and a plurality of columnar prism portions 88, triangular in cross section and disposed in parallel on one side (the front side) of the substrate portion 88. The peak angle of the columnar prism portion 88 is preferably in a range from 60-150°. The substrate portion 86 and the columnar prism portion 88 are composed of the same type of transparent material as in the first embodiment.

The first prism sheet 78 and the second prism sheet 80 are overlapped so that the columnar prism portions 84 and 88 extend at mutual right angles, and the second prism sheet 80 columnar prism 88 contacts the reverse surface of the first prism sheet 78. Furthermore, ionizing radiation curable resin R is filled into the space between the second prism sheet 80 columnar prism 88 and the first prism sheet 78 substrate portion 82, and the first prism sheet 78 and the second prism sheet 80 as integrated as a single piece.

In the present embodiment a UV beam curing resin, electron beam curing resin, or the like is used as the ionizing radiation curable resin R. A resin with a post-curing index of refraction more than 0.05 below that of the second prism sheet 80 prism portion 88 is used as the ionizing radiation curable resin R.

There is also a method whereby instead of the ionizing radiation curable resin R, a solvent is filled in which tacky, fine particles with smaller particle diameter than the prism pitch are dispersed, the solvent is evaporated, and lamination is performed. An air layer is thus established between the prism side s and the particles.

Fine particle acrylic tacking agents, natural rubber tacking agents, urethane tacking agents, and silicon tacking agents may be used as sticky fine particles. The tacky fine particles may be spherical or irregularly shaped.

FIG. 12(a) shows a ray trace for a configuration in which a prism sheet 92 with a prism portion 90 having a peak angle of 90° is disposed on a diffusion panel 94. The index of refraction nₚ of the prism portion 90 and the light guide panel is 1.49. As shown in FIG. 12(a), a polarizing angle of 16° can be obtained when emitting into air (index of refraction nₐ=1.0). However, when a prism portion is formed of resin having an index of refraction of 1.595 and a resin having an index of refraction of 1.49 is filled around this prism portion, virtually no polarizing angle can be obtained when emitting from the prism portion 90 into the resin.

As shown in FIG. 12(b), a polarizing angle of approximately 9° can be obtained by setting the prism portion peak angle to 40°. As further shown in FIG. 12(c), a polarizing angle of 9° can be obtained using a prism portion peak angle of 40°. Furthermore, as shown in FIG. 12(c), a polarizing angle of 14° can be obtained using an index of refraction of 1.4 for the filling resin R and a prism portion peak angle of 40°. The index of refraction of the substrate portion is 1.49.

Sulfurous acrylate, fluorene derivatives, and the like are used as a high index of refraction (nₕ) resins to form the prism portion. Acrylic urethane or fluorinated acrylate are used as a low index of refraction resin (nᵢ).

We next discuss a light polarizing sheet 96 in a sixth embodiment of the present invention. FIG. 13(a) is a schematic cross sectional view of the light polarizing sheet 96; FIG. 13(b) is a schematic cross sectional view along line b-b in FIG. 13(a).

The light polarizing sheet 96 of the present embodiment integrates into a single piece the diffusion sheet, diffusion film, and prism sheet used in conventional direct backlights.

As shown in FIG. 13, the light polarizing sheet 96 comprises a columnar prism portion (first polarizing lens portion) 100, triangular in cross section and disposed in parallel on one side (the front side) of the flat sheet-shaped substrate portion 98. The cross section of the columnar prism portion (first polarizing lens portion) 100 is preferably a triangle having a peak angle of not less than 60° and not greater than 150°.

The light polarizing sheet 96 also comprises a columnar (second polarizing lens portion) 102, trapezoidal in cross section and disposed in parallel on the other side (the reverse side) thereof. The shape of the trapezoid is defined by removing the peak portion of a triangle having a peak angle of not less than 60° and not greater than 150°.

The columnar lens portion (second polarizing lens portion) 102 is disposed to extend perpendicularly with respect to the triangular cross section columnar prism portion (first polarizing lens portion) 100. The columnar lens portion (second polarizing lens portion) 102 is configured such that light incident at a low angle on an internal sloped surface is fully reflected in the vertical direction. The angle and shape of this sloped surface are appropriately selected in accordance with required viewing angles. The columnar prism portion (first polarizing lens portion) 100 and the columnar lens portion (second polarizing lens portion) 102 may also be simultaneously formed on both sides of the substrate portion 98.

Moreover, the light polarizing sheet 96 comprises a diffusion sheet 104 adhered to the peak surface of the columnar lens portion (the second polarizing lens portion) 102 using a tacking agent or adhesive.

The light polarizing sheet 96 of this configuration is disposed over a linear light source 4 such as a CCFL inside a liquid crystal display device backlight as shown, for example, in FIG. 14.

We next discuss a light polarizing sheet 106 in a seventh embodiment of the present invention. FIG. 15(a) is a schematic cross sectional view of a seventh embodiment light polarizing sheet 106; FIG. 15(b) is a schematic cross sectional view along line b-b in FIG. 15(a).

The light polarizing sheet 106 of the seventh embodiment comprises a first polarizing lens sheet 108 and a second polarizing lens sheet 110. The first polarizing lens sheet 108 has the same configuration as the isotropic lens sheet 14 in the first embodiment, and the second polarizing lens sheet 144 has the same configuration as the prism sheet 12 in the first embodiment. The first and second polarizing lens sheets 108 and 110 are laminated (or adhered) together in the same manner as the isotropic lens sheet 14 and the prism sheet 12 in the first embodiment.

A diffusion panel 112 is attached to the second polarizing lens sheet 110 opposite the first polarizing lens sheet 108 via an air layer A. A plurality of protuberance structures 114 are formed on the reverse side of the second polarizing lens sheet 110 to secure an air layer between the diffusion sheets 112. The protuberance structures 114 are rod-shaped bodies approximately rectangular in section, and the tip surface of the protuberance structures 114 is stuck on to the diffusion sheet 112 using a clear tacking agent or adhesive.

The protuberance structures 114 are preferably formed of a composition such as (meta) acrylate active energy beam curing composition or the like. Examples of a (meta) acrylate active energy beam curing composition include (meta) acrylate resins such as polyester (meta) acrylate, epoxy (meta) acrylate, urethane (meta) acrylate and the like.

Methods for forming the protuberance structures 114 include those in which columnar structures serving as protuberance structures are preformed on a sheet or roll of film or the like and transferred by heat or adhesive to the reverse side of the second polarizing lens sheet; casting methods using a die roll on which protuberance structure shapes are preformed; a photopolymerization (2P) method using ion radiation curing resin, printing methods such as intaglio flexographic and screen printing, and formation by potting by inkjet or the like.

Moiré fringes may occur depending on the lens alignment pitch of the second polarizing lens sheet 110 and the protuberance structure 114 alignment pitch. To prevent this type of moiré fringes, it is preferable to make one of the alignment pitches random, or to set one of the alignment pitches to be between (N+0.4) and (N+0.6) times the other alignment pitch (where N is an integer).

The polarizing lens sheet of the present embodiment comprises an isotropic lens sheet and a prism sheet, but the polarizing lens sheets described in the second through fifth embodiments could also be used in place of the isotropic lens sheet.

Next we discuss a light polarizing sheet 116 of an eighth embodiment of the present invention. FIG. 16(a) is a schematic cross sectional view of light polarizing sheet 116 of the eighth embodiment; FIG. 16(b) is a schematic cross sectional view along line b-b in FIG. 16(a).

The light polarizing sheet 116 shown in FIG. 16 comprises a prism sheet 122 in which a plurality of triangular cross section columnar prism portions 120 are disposed in parallel on one side (the front side) of a flat substrate portion 118. The peak angle of the columnar prism portion 120 is preferably in a range from 60-150°.

At the same time, a diffusion sheet 124 is disposed opposite to the other side (the reverse side) of the substrate portion 118. A plurality of semicircular column-shaped lens portions 126 formed of resin are disposed in parallel on the side of the diffusion sheet 124 opposing the prism sheet 122. Furthermore, a resin having an index of refraction no less than 0.05 greater than that of the resin forming the lens portions 126 is filled in between the other side of the substrate portion 118 and the lens portion 126.

Next we discuss a light polarizing sheet 130 of a ninth embodiment of the present invention. FIG. 17(a) is a schematic cross sectional view of the light polarizing sheet 130 of the eighth embodiment; FIG. 17(b) is a schematic cross sectional view along line b-b in FIG. 17(a).

The light polarizing sheet 130 shown in FIG. 17 comprises a structure in which columnar portions 134 having a trapezoidal shape in cross section are disposed on the surface of the diffusion sheet 132, and the isotropic lens sheet 136 substrate portion 138 is stuck on to the peak surface of the columnar portions 134. Isotropic lens sheet 136 has the same configuration as the isotropic lens sheet 14 of the first embodiment.

It is preferable that the side s of the columnar portions 134 have a large angle of inclination in order to assure a large polarizing angle with respect to light incident within the lens at low angles. In the embodiment, the angle of inclination of the columnar portions 134 is set at 70°. Beads with a small curvature and a diameter of 5-10 μm were used as the beads 140 for the first polarizing lens 136.

The polarizing lens sheet of the present embodiment comprises an isotropic lens sheet and a diffusion sheet, but the light polarizing sheet described in the first through fifth embodiments could also be used in place of the isotropic lens sheet.

Next we discuss a light polarizing sheet 142 in a tenth embodiment of the present invention. FIG. 18 is a schematic cross sectional view of light polarizing sheet 142 of the tenth embodiment.

As shown in FIG. 18, the light polarizing sheet 142 comprises a prism sheet 144 and a diffusion sheet 146. The prism sheet 144 comprises a flat sheet-shaped substrate portion 148 and a plurality of triangular cross section columnar prism portions 150 disposed in parallel on one side (the front side) of the substrate portion 148.

Each of the columnar prism portions 150 has a peak angle of 90° and is disposed at a pitch of 48 μm. The columnar prism portions 150 are formed of UV curing resin, and the substrate portion 148 is formed of polyester resin.

The diffusion sheet 146 is stuck onto the prism sheet 144 by a UV cured pressure-sensitive adhesive disposed in discrete portions on the reverse side of the substrate portion 148 of the prism sheet 144. Because the pressure-sensitive adhesive 152 is disposed in discrete portions, air layers are formed between the prism sheet 144 substrate portions 148 and the dispersion sheet 146 in parts where no pressure-sensitive adhesive 152 is disposed.

The dispersion sheet 146 is a PMMA (polymethyl metacrylate) sheet on which titanium oxide particles are dispersed, with a total light transmissivity of 65% and a diffusion rate of 45%. Polystyrene resin, MS resin (metacryl stryrene copolymer resin), AS resin (acrylonitrile styrene copolymer), polycarbonate resin, polyester resin, or polyolefin resin sheet may be used in place of PMMA sheet.

Pressure-sensitive adhesive 152 is of the UV curing type and can be applied at room temperature. The pressure-sensitive adhesive 152 of the present embodiment contains a light polymerizing acrylurethane oligomer with a molecular weight of 5000-30000, an acrylmonomer with a molecular weight of approximately 1000 or less, and a light polymerization initiator. No solvent is used in the pressure-sensitive adhesive 152 of the present embodiment.

The UV curing reaction has a fast reaction time and makes use of radical reactions with high transparency and thermal stability. These have a property, however, by which curing is made difficult due to oxygen inhibition, therefore a nitrogen purge is performed at the half-cured stage.

The shape of the pressure-sensitive adhesive 152 on the reverse side of the substrate portion 148 of the prism sheet 144 depends on the contact angle with the substrate portion 148 and the viscosity of the pressure-sensitive adhesive 152 at the time of application, the method of application, and the like. In the present embodiment, an anchor coating and surface treatment are applied to the reverse side of the substrate portion 148 to improve bonding with the pressure-sensitive adhesive 152. A colloidal silica may be added to the adhesive to improve viscosity and thixotropy.

The pressure-sensitive adhesive 152 is disposed in discrete portions by ink jet, flexographic printing, or continuous screen printing. FIG. 19 shows a pattern for discreet disposition of the pressure-sensitive adhesive.

In the pattern shown in FIG. 19(a), a dot-shaped pressure-sensitive adhesive 152 is randomly disposed in order to prevent a moiré effect with the prism sheet or the liquid crystal display panel. The size of a single dot is set at 35 μm in diameter, and the center to center average spacing is set at 215 μm.

In the pattern shown in FIG. 19(b), laterally elongated elliptical pressure-sensitive adhesive pads 152 are randomly disposed. Adoption of this type of anisotropic shape enables the adjustment of both the horizontal and vertical viewing angles.

In the pattern shown in FIG. 19(c), the pressure-sensitive adhesive 152 is disposed in a striped shape extending in a direction perpendicular to the direction in which the prism sheet 144 columnar prism portion extends. In the present embodiment, line width is set, for example, at 35 μm, and pitch at 215 μm.

In the pattern shown in FIG. 19(d), the pressure-sensitive adhesive 152 is disposed in a striped shape which is sloped with respect to the direction in which the prism sheet 144 columnar prism portion extends. In the present embodiment, line pitch is set at 215 μm.

Using this structure, the pressure-sensitive adhesive not only serves the role of ensuring an air layer between the diffusion sheet and the prism sheet, but also has the effect of suppressing losses from Fresnel reflection off the reverse side of the prism sheet 144 substrate portion 148.

Next we discuss the configuration of the light polarizing sheet 154 of an eleventh embodiment of the present invention. FIG. 20(a) is a schematic cross sectional view of light polarizing sheet 154 of the eleventh embodiment of the present invention; FIG. 20(b) is a schematic cross sectional view along line b-b in FIG. 20(a).

As shown in FIG. 20, the light polarizing sheet 154 of the eleventh embodiment comprises a prism sheet 156 and a diffusion sheet 158.

The prism sheet 156 comprises a flat sheet-shaped substrate portion 160, a plurality of columnar prism portions 162, triangular in section and disposed on one side (the front side) of the substrate portion 160, and a plurality of columnar portions 164 disposed on the other side (the reverse side) of the substrate portion 160. The peak angle of the columnar prism portion 162 is preferably 60°-150°. The column portions 164 are rod-shaped bodies with a trapezoidal cross section, disposed in parallel separate from one another so as to extend parallel to the prism portion 162.

In the present embodiment, the prism sheet 156 and the diffusion panel 158 are integrated as a single piece by the sticking on of the tip of the columnar portions 164 to the pressure-sensitive adhesive layer 166 which is coated onto the front side of the diffusion sheet 158.

Next we discuss the configuration of a light polarizing sheet 170 in a twelfth embodiment of the present invention. FIG. 21(a) is a cross sectional view of the light polarizing sheet 170; FIG. 21(b) is a cross sectional view along the line b-b of (a).

As shown in FIG. 21, the light polarizing sheet 170 comprises a first prism sheet 172 and a second prism sheet 174.

The first prism sheet 172 comprises a flat sheet-shaped substrate portion 176 and a plurality of columnar prism portions 178, triangular in section and disposed in parallel on one side (the front side) of the substrate portion 176. The substrate portion 176 and the columnar prism portion 178 are constituted of the same type of transparent material as in the first embodiment above.

The second prism sheet 174 also comprises a flat sheet-shaped substrate portion 180 and a plurality of columnar prism portions 182, triangular in section and disposed in parallel on one side (the front side) of the substrate portion 176. The substrate portion 180 and the columnar prism portion 182 are constituted of the same type of transparent material as in the first embodiment above.

The first prism sheet 172 and the second prism sheet 174 are disposed in such a way that columnar prism portions 178 and 182 extend perpendicularly to one another.

A tacky layer 184 comprising transparent resin is provided on the other side (reverse side) of the first prism sheet 172 and the substrate portion 176. The tacky layer 184 comprises a tacking agent or an adhesive; the first prism sheet 172 and the second prism sheet 174 are integrated into a single piece by the burying of the tip of the second prism sheet 174 prism portion 184 in this tacky layer.

By changing the peak angle of each of the prism sheets, the viewing angle in the horizontal or vertical directions can be controlled in such as way that the viewing angle required for each display is attained.

Letting X be the columnar prism portion peak angle which controls the horizontal field, and Y the columnar prism portion peak angle which controls the vertical field, the peak angle of the columnar prism portions 178 and 182 preferably satisfies Formulas (1) through (3) below:

70°≦X≦150° Formula (1)

70°≦Y≦130° Formula (2)

195°≦X+Y≦225° Formula (3)

Using a light polarizing sheet for which the peak angles X and Y satisfy the conditions of Formulas (1) through (3) above, the luminance peaks emitted in the diagonal direction with respect to the backlight normal line direction, which are known as the side lobes, can be suppressed and the amount of viewing angle-induced backlight dark/light variation caused by viewing the backlight at differing viewing angles can be reduced.

The peak angles X and Y preferably satisfy Formulas (4) through (6):

90°≦X≦≦140° Formula (4)

80°≦Y≦120° Formula (5)

200°≦X+Y≦240° Formula (6)

With a light polarizing sheet satisfying these conditions, high luminance and wide viewing angle can both be achieved.

The prism sheet with the peak angle X that controls the horizontal field direction is disposed on the lower side (the first light polarizing sheet) and the prism sheet with the peak angle Y that controls the vertical field direction is disposed on the upper side (the second light polarizing sheet); a light polarizing sheet satisfying Formulas (4) through (6) above as well as Formula (7) below is capable of achieving higher luminance and viewing angle.

X≧Y Formula (7)

We next discuss a manufacturing method for obtaining the light polarizing sheet embodiments of the present invention. Tacking agent or adhesive is first applied to the other side (the reverse side) of the first sheet substrate portion or the second sheet flat portion or both. The method for coating this tacking agent or adhesive includes publicly known coating technologies such as described in the book “New Tacking (Tacky Adhesive) Technologies and their Applications, Development Materials for Various Application Products,” p. 626, FIG. 15 (Management Education Department, Management Development Center, Editors, issued May 20, 1978).

These coating technologies are selected as appropriate in accordance with factors such as the viscosity of the tacking agent coating fluid, coating thickness (and film thickness accuracy), and coated film format (coverage of entire surface, partial coverage, etc.).

Die coaters, gravure coaters, roll coaters, reverse roll coaters, or comma coaters are preferable for coating a tacking agent over the entire surface of the other side (reversed side) of the first sheet substrate portion, as in the light polarizing sheet set forth in the first through third embodiments and the twelfth embodiment.

Methods for coating a tacking agent or adhesive onto the flat portion of the second sheet include the method in which a flat portion of the lens is caused to contact a roll on which tacking agent has been coated or a tacky sheet has been formed, thereby transferring tacking agent to the lens flat portion, and printing methods using an inkjet printer.

Flexographic printing, rotary screen printing, or coating with an embossed roll using a transfer printing roll or a screen plate on which a dot or stripe pattern is formed are methods used to coat the tacking agent in discrete dot or striped shapes onto the other side (the reverse side) of the first sheet substrate portion, as in the light polarizing sheet set forth in the fourth embodiment.

In the light polarizing sheet noted in the twelfth embodiment, differences in the depth at which the prism tip is buried in the tacking agent tend to increase variability in optical properties, therefore in order to keep the depth of the buried prism tip constant requires coating with a high accuracy of adhesive thickness.

Surface modification treatment of the other side (the reverse side) of the sheet substrate portion can be performed with the goal of improving substrate portion surface wetting characteristics or adhesion with the tacking agent or the adhesive. Methods of surface treatment include corona discharge treatment, ozone treatment, plasma treatment, EB treatment, and other known technologies.

Tacking agents or adhesives are cured after coating by heating or by ion beam radiation as with UV, electron beams, or the like. Known devices are used as the heating devices or UV and electron beam or other ion beam radiation devices for curing the tacking agent or the adhesive. To avoid damage to the light polarizing sheet substrate portion, the curing treatment is preferably performed at a temperature such that the temperature of the substrate portion is below the allowable temperature limit thereof. Particularly with electron beam irradiation it is preferable, in view of the potential damage to the light polarizing sheet substrate, that the device be of the under 300 kV low acceleration electron beam type.

After the tacking agent cures, the first sheet and the second sheet are laminated (or adhered) together by a known laminating device such as a hot laminator or a cold laminator. The pressure during lamination is set in consideration of the lens shape for forming the light polarizing sheet, the properties of materials used for that purpose, and the material properties of the tacking agents or the adhesives used.

In the present embodiment a resin with post-curing tackiness was used (to laminate two sheets), but it is also acceptable to laminate two sheets before (the tacking agent is) cured. After laminating two sheets, the tacking agent may be cured by UV irradiation to affix two sheets. In such cases, in the light polarizing sheets in the first through the fourth embodiment, tacking agent prior to curing applied at the flat portion of the lower prism sheet prism portion tip overflows on the sloped surface of the prism tip when laminated (or adhered), making it easy for the tip portion to be buried in the tacking agent.

In this type of light polarizing sheet, the tendency toward variability in the optical characteristics of a light polarizing sheet obtained with differing depths at which prism tips are buried in the tacking agent requires that the depth of the buried prism tip be constant, and high accuracy coating and lamination pressure control are required in order to obtain a uniform adhesive coating thickness.

Moreover, non-carrier tacky sheets on which a pre-cured tacky layer is disposed on a peelable paper, or sanded on two sides of a peelable paper, or tacky sheets provided with a hot melt tacky layer which is solid at room temperature but melts under heat, may be used.

Examples of methods for use with non-carrier sticky sheets or hot melt sticky sheets include the method in which sheets such as a prism sheet and non-carrier tacky sheets are separately supplied, and lamination is done in one pass using a laminator, as well as the method in which a non-carrier tacky sheet or a hot melt sticky sheet is laminated (or adhered) beforehand to the reverse side of one sheet to form a tacky layer, and the other sheet is then supplied and laminated (or adhered).

When continuously manufacturing the light polarizing sheet of the above embodiments, the first and second sheets are respectively unwound from rolls, the tacking agent or adhesive is coated onto flat surfaces of the columnar prism portion or the like of the second sheet and/or the other side (the reverse side) of the first sheet, the flat surfaces of the columnar prism portion or the like of the second sheet are laminated (or adhered) to the other side (the reverse side) of the first sheet using a laminator, and the first and second sheets are integrated into a single piece.

Next we discuss a method for manufacturing the light polarizing sheet of the seventh embodiment.

The first polarizing lens sheet 108 and second polarizing lens sheet 110 are manufactured by the method described above.

The plurality of protuberance structures 114 on the second polarizing lens sheet 110 is formed by methods such as a method in which columnar structures serving as protuberance structures, pre-formed on a film or other sheet or on a roll, are transferred to the reverse side of the second lens sheet by heat or adhesive, a casting method using a die roll pre-formed in the shape of the protuberance structure, a 2P using ion radiation curing resin, flexographic printing or screen plate printing using printing plates, potting using inkjets, and the like.

When adhering tip surface of the protuberance structure 114 on the second polarizing lens sheet 110 with the diffusion sheet 112, the same types of technologies as used in the light polarizing sheet manufacturing method can be applied to the methods for coating and curing the tacking agent and for laminating. Tacking agent or adhesive is applied to one or both of the lamination surfaces of the protuberance structure 114 and the diffusion sheet 112.

We next discuss a manufacturing method for the light polarizing sheet 142 in the tenth embodiment.

As shown in FIGS. 22 and 23, the prism sheet 144, to which a protective film 186 is attached, is supplied from a roll to the columnar prism portion 150. A pressure-sensitive adhesive 152 is coated on in a predetermined pattern on the reverse side of the substrate portion 148 using a coating device 188 such as an inkjet printer or the like.

The coated on pressure-sensitive adhesive 152 is cured immediately using a UV device 190 (FIG. 22(a), FIG. 23). Next, the diffusion sheet 146 is overlaid, and the prism sheet 144 and the dispersion sheet 146 are pressed together using a pressure roller 192 and laminated (or adhered) (FIG. 22(b), FIG. 23). The laminated (or adhered) light polarizing sheet is punched into a size fitting the backlight using a cutter 194 or the like (FIG. 23).

At this point, after placing the light polarizing sheet in a semi-cured state in the curing stage using the UV device 190, curing can be completed by applying UV light again from the protective film 168 or the dispersion sheet 146 side after overlaying the dispersion sheet 146.

When a hard acrylic sheet of approximately 0.65 mm thickness is used as the dispersion sheet 146, the light polarizing sheet manufactured using a roll-to-roll machine in which the dispersion sheet 146 is supplied from a roll and the completed light polarizing sheet is taken up on a roll as shown in FIG. 23.

Many variations and alternative forms of the present invention are also possible within the scope of the technical concepts set forth in the claims, not limited to the embodiments above.

### Example

We now discuss example of the present invention.

We simulated the correlation between prism sheet prism peak angle and light polarizing sheet light level luminosity or light intensity (luminance) and viewing angle characteristics in the light polarizing sheet of the third embodiment shown in FIG. 9.

Backlight optical characteristics were calculated using an optical simulation software package (Light Tools) from US company ORA (Optical Research Associates).

The optical models used in the simulation were as follows.

For a first prism sheet model, which primarily controls the vertical viewing angle, multiple models were designed using a sheet on which columnar prism portions, trapezoidal in section, are formed at a pitch of 50 μm on one side (the front side) of a 20 mm high, 20 mm wide, 0.1 mm thick substrate portion, with peak angles differing in 10 degree increments over a range of 60° to 150°.

For a second prism sheet model, which primarily controls the horizontal viewing angle, multiple models were designed using a sheet on which columnar prism portions, triangular in section, are formed at a pitch of 50 μm on one side (the front side) of a 20 mm high, 20 mm wide, 0.1 mm thick substrate portion, with peak angles differing in 10 degree increments over a range of 60° to 150°.

The index of refraction of all parts of the above model was set at 1.5, and the surface characteristic of each part was set to have a smooth optical Fresnel reflection characteristic.

These first and second prism sheets were modeled as a laminated (or adhered) light polarizing sheet as shown in FIG. 9. Furthermore, a rectangle 0.6 mm high and 0.6 mm wide with a thickness of 0.01 mm disposed 22 mm below the center portion of the light polarizing sheet model was used as a light source model.

A light emission pattern (angular luminance distribution) measured from a direct backlight actually fabricated using CCFLs and a diffusion panel was used for the light source information. Specifically, measurement of the light emitting pattern was conducted using a direct backlight light source 210 described below in accordance with FIG. 25 to measure the angular luminosity (light intensity) distribution of a diffusion panel (Mitsubishi Rayon Acrylite; color hue NA8; thickness 2 mm).

Using an ELDIM EZcontrast 160R (conoscope), angular luminance distribution was measured over a range of −80° to +80° at the center of the backlight. To make the measurement, the direct backlight was illuminated and left on for 30 minutes. The angular luminance data obtained was output in 1° increments, multiplied by cos θ (here θ is the light emission angle), and converted to luminosity data for use as light source information in the simulation.

A rectangular body 20 mm high, 20 mm wide, and 0.01 mm thick disposed as a reflective sheet under the bottom side of the light source model was used as the reflective sheet model. The surface characteristics of the parts comprising the reflective sheet model were set to be those of a simple mirror (98% reflectivity; 2% transmissivity).

The Far Field light receiver in Light Tools was used as the light receiver in the simulation, centered on the middle of the uppermost surface of the light polarizing sheet model. The Far Field light receiver was disposed using the center of the polarizing sheet as a reference point to simulate luminosity at all angles (over the entire sphere). Note that unit setting for brightness in the light receiving device was performed using luminosity, and the number of light rays in the simulation was set at one million.

Luminosity data obtained was output in 2° increments in the vertical direction and 5° increments in the horizontal direction. Table 1 shows the front surface luminosity (brightness) as well as vertical and horizontal half angle luminosity (the angle at which front surface luminosity drops to 50%). Note that the luminosity between each angle data point was obtained by linear approximation using the closest two points (interpolated luminosity data obtained by the approximation formula is underlined in Table 1).

The optical characteristics of the prism peak angles which were not simulated were calculated by linear approximation using two data points at the closest prism peak angles from the results of the simulation.

The viewing angle characteristics required for the backlight differ depending on the mode of the liquid crystal display device installed and the optical film used, as well as by purpose. For example, in a liquid crystal TV application, the horizontal viewing angle characteristics are designed to be wider than the vertical viewing angle characteristics, and the same characteristics are also sought for the backlight viewing angle.

Therefore the combination of each prism sheet prism peak angle is selected as appropriate in accordance with the luminosity (luminance) and viewing angle required for the backlight.

In Table 1, the highest luminosity (brightness) is obtained when two prism sheet prism peak angles of 90° and 90° are combined, but it can be seen that viewing angle characteristics are narrowed. The viewing angle characteristics of this combination are too narrow for use in displays such as liquid crystal TV, which require broad viewing angles and high luminance. The viewing angle does broaden when two prism sheet prism peak angles of 150° and 150° are combined, but it can seen that in this case sufficient luminosity is not obtained. It can also be seen that when prism peak angles of 60° and 60° are combined, the viewing angle is narrow and sufficient luminosity is not obtained.

TABLE 1

| | | Peak Angle X of the Second Prism Sheet (polarizing lens controlling the horizontal viewing direction) | | | | | | | | | |
|---|---|---|---|---|---|---|---|---|---|---|---|
| | | 60 | 70 | 80 | 90 | 100 | 110 | 120 | 130 | 140 | 150 |
| Peak Angle Y | 60 | 0.451 | 0.555 | 0.613 | 0.63 | | 0.577 | 0.552 | 0.535 | 0.51 | 0.487 |
| of the First Prism | | 53/33 | 35/38 | 31/34 | 34.5/40 | | 45/52 | 46/58 | 50/58 | 53/62 | 55/67 |
| Sheet (polarizing | 70 | 0.577 | 0.62 | 0.702 | 0.724 | 0.673 | 0.621 | 0.6 | 0.565 | 0.556 | 0.524 |
| lens controlling | | 45/30 | 41/43 | 38/42 | 41/46 | 49/52 | 52/60 | 52/64 | 56/67 | 58/71 | 60/75 |
| the vertical | 80 | 0.679 | 0.68 | 0.804 | 0.812 | 0.764 | 0.706 | 0.65 | 0.644 | 0.61 | 0.588 |
| viewing direction) | | 42/35 | 48/50 | 43.5/47.5 | 47.5/51 | 53.5/57 | 56/62 | 57.5/69 | 60.5/71 | 63/76 | 65/80 |
| | 85 | | | 0.839 | 0.856 | 0.805 | 0.728 | 0.68 | 0.655 | 0.642 | 0.607 |
| | | | | 46/50 | 50/53 | 56/59 | 59/64 | 60/70 | 63.5/73 | 66/78 | 68/82 |
| | 90 | 0.755 | 0.72 | 0.868 | 0.89 | 0.834 | 0.756 | 0.72 | 0.684 | 0.663 | 0.64 |
| | | 44/42 | 53/55 | 49/52 | 53/57 | 59/61 | 61/67 | 63/72 | 66/76 | 68/80.5 | 69/85 |
| | 95 | 0.728 | | 0.85 | 0.869 | 0.822 | | 0.715 | | | 0.64 |
| | | 46/43 | | 52/53.5 | 55.5/59 | 61/62 | | 65/72.5 | | | 72/87 |
| | 100 | 0.714 | 0.761 | 0.82 | 0.814 | 0.772 | 0.738 | 0.69 | 0.676 | 0.63 | 0.621 |
| | | 49/49 | 51/52 | 55/58 | 58/62 | 64/68 | 66/71 | 67/77 | 71/79 | 74/85 | ’74/88.5 |
| | 105 | | | | 0.778 | 0.762 | 0.694 | 0.67 | | | |
| | | | | | 61/63 | 66/69 | 69/73 | 70/79 | | | |
| | 110 | 0.61 | 0.66 | 0.703 | 0.744 | 0.7 | 0.662 | 0.622 | 0.61 | 0.58 | 0.57 |
| | | 67.5/52 | 63/56 | 63/60 | 64/63 | 71/69 | 72/73 | 73/81 | 76/82 | 79/87 | 80/91 |
| | 115 | 0.6 | | 0.659 | 0.685 | 0.653 | 0.621 | 0.597 | 0.568 | 0.552 | 0.544 |
| | | 74/52 | | 68/61 | 68/66 | 75/70 | 76/74 | 76/80 | 79/83 | 82/88 | 83/92 |
| | 120 | 0.574 | 0.6 | 0.64 | 0.65 | 0.622 | 0.588 | 0.55 | 0.53 | 0.53 | 0.51 |
| | | 75(64)/52 | 76/58 | 68/61.5 | 70/67 | 77/71 | 80/77.5 | 80/82 | 83/87.5 | 84.5/90 | 85/95 |
| | 125 | | | 0.63 | 0.63 | | 0.577 | 0.537 | | 0.512 | 0.5 |
| | | | | 67/64 | 71/69 | | 80/79 | 82/84 | | 87/92 | 88/97 |
| | 130 | 0.55 | 0.59 | 0.62 | 0.63 | 0.6 | 0.56 | 0.53 | 0.5 | 0.51 | 0.47 |
| | | 76/54 | 66/59 | 70/64 | 74/69 | 80/75 | 82/80.5 | 83/85 | 87/90 | 88/94 | 90/99 |
| | 140 | 0.52 | 0.56 | 0.6 | 0.6 | 0.58 | 0.55 | 0.51 | 0.49 | 0.48 | 0.46 |
| | | 76/58 | 73/61 | 76/66 | 79/70 | 85/76 | 88/79 | 89/86 | 92.5/77 | 95/96 | 95.5/99 |
| | 150 | 0.518 | 0.54 | 0.577 | 0.584 | 0.56 | 0.531 | 0.489 | 0.47 | 0.455 | 0.438 |
| | | 77/59 | 77/62 | 81/68 | 84/71 | 90/77 | 93/80.5 | 94/87.5 | 97/91 | 100/97 | 101/101 |

| | |
|---|---|
| Upper Row | Luminosity |
| Lower Row | Vertical/Horizontal |

We shall discuss an example of the light polarizing sheet of the present invention which was actually fabricated based on the results of the foregoing simulation, comparing it with a comparative example.

### Comparative Examples

Comparative Example 1 has the configuration of a direct backlight as currently used.

A GM2 Light-Up diffusion film manufactured by KIMOTO was used as the first polarizing/diffusion film (isotropically controlling vertical/horizontal viewing angles), and a peak angle=90°, prism pitch=50 μm 3M Company BEFII (primarily controlling the vertical viewing angle) was used as the second prism sheet.

### Comparative Examples 2-4

A prism sheet with the prism peak angle shown in Table 2 and a prism pitch=50 μm was used as the prism sheet (primarily determines the vertical viewing angle).

TABLE 2

| | Peak Angle X | Peak Angle Y | | | | |
|---|---|---|---|---|---|---|
| | of the Second | of the First | | | | |
| | Light | Light | | | | |
| | Polarizing | Polarizing | | | | |
| | Sheet | Sheet | Luminance | Half Max. Angle | | |
| | Polarizing | Polarizing | cd/m² at an | Vertical | Horizontal | Quality (Lamp |
| | Lens | Lens | Angle of 0° | Direction | Direction | Image) |
| Example 1 | 120 | 100 | 4759 | 67 | 84 | ∵ |
| Example 2 | 120 | 63 | 3893 | 53 | 69.5 | ∵ |
| Example 3 | 120 | 68 | 4047 | 53 | 69.5 | ∵ |
| Example 4 | 120 | 90 | 5154 | 60 | 73 | ∵ |
| Example 5 | 120 | 120 | 4056 | 80 | 82 | ∵ |
| Example 6 | 100 | 100 | 4995 | 62 | 76 | ∵ |
| Example 7 | 100 | 120 | 4221 | 74 | 80.5 | ∵ |
| Comp. Ex. 1 | Diffusion | 90 | 4542 | 66.5 | 81.5 | ∵ |
| | Sheet | | | | | |
| Comp. Ex. 2 | — | 90 | 4366 | 73.5 | 109.5 | x |
| Comp. Ex. 3 | — | 100 | 4415 | 80 | 113.5 | x |
| Comp. Ex. 4 | — | 120 | 3854 | 94 | 125.5 | x |

### Example 1

As shown in FIGS. 24(a) and 24(b), the light polarizing sheet 200 of the present example is a sheet of the same configuration as that in the FIG. 9 light polarizing sheet 62, in which a first prism sheet (primarily controlling the vertical viewing angle) 202, and a second polarizing lens sheet (primarily controlling the horizontal viewing angle) are laminated (or adhered) together.

In the present example, a lens sheet in which lens portions with a peak angle θ1=100 and a prism pitch P2=50 μm are formed on one side (the front side) of a 125 μm clear PET film treated for easy adhesion was used as the first prism sheet (primarily controlling the vertical viewing angle) 202. A lens sheet in which lens portions with a peak angle of θ2=120°, a tip flat portion width s=5 μm, and a prism pitch P1=73 μm were formed on one side (the front side) of a 188 μm thick PET film treated by clear single-sided diffusion panel treatment (treated for easy adhesion) was used for the lens sheet (primarily controlling the horizontal viewing angle) 204.

A UV curing resin (No-Tape Industrial Co., Inc. “Acrytack T-510”) was coated at a coating speed of 1 m per minute and a coating thickness of approximately 20 μm using a bar coater. These UV-cured resins have post-cure tackiness and can be easily optically sealed.

After coating, UV rays were irradiated using a pulse xenon UV irradiation device (US Co. Xenon, RC-747) to cure a UV curing resin and form a tacky layer. Conditions for UV irradiation were 5 second pulsed irradiation (approximately 50 pulses) repeated 5 times. The cumulative amount of UV radiation in this period was 20 mJ/cm² (peak wavelength measurement: 360 nm).

After curing, the two prism sheets were laminated (or adhered). The prism sheet 200 obtained was cut into samples 325 mm high×425 mm wide. When observed in section under a microscope, the second prism sheet tip flat portion was sealed to the tacky layer formed on the reverse side of the first prism sheet.

### Example 2-7

Using a 125 μm thick PET film conditioned for easy adhesion in lieu of the 188 μm thick PET film used in the second prism sheet, the same procedure was performed as in Example 1 except for the fabrication of a prism sheet with the peak angle noted in Table 2.

### (Structure of the Direct Backlight)

A cross section of the direct backlight 210 used to measure optical properties in the present example is shown in FIG. 25.

The backlight light source 210 is of the 20 inch size (325 mm high×425 mm wide), in which 10 CCFL212s with a diameter of φ3 mm are parallelly disposed as a light source. A white diffusion panel reflecting sheet 214 is disposed under the CCFL212. The CCFL212 is disposed with a pitch P1 of 30 mm and a distance H2 from the diffusion panel reflecting sheet 214 of 3.5 mm.

In the diffusion panel sheet 214, the region W2 directly beneath the CCFL212s is a 15 mm wide plane, and the region W1 between adjacent CCFL212s is a triangular convex portion 15 mm wide and 7 mm high (H3).

A diffusion panel 216 (Mitsubishi Rayon Acrylite; color hue NA88; thickness 2 mm) is disposed above the CCFL212s. The distance H3 between the CCFL212s and the diffusion panel 216 is set at 13.5 mm. Direct backlights were fabricated by placing the light polarizing sheets of Examples 1-7 and Comparative Examples 1-4 on the diffusion panels above.

### (Method for Evaluating Luminance and Viewing Angle Characteristics)

Angular luminance distribution at the center of the backlight was measured using an ELDIM EZcontrast 160R (conoscope) after a direct backlight constituted as described above was illuminated and left on for 30 minutes. The luminance value at the front (angle 0°) of the obtained angular luminance data was used for the front (angle 0°) luminance value.

Vertical and horizontal viewing angle characteristics were set by multiplying cos θ (here θ is the light emission angle) times the angular luminance value at each obtained angle and converting luminance to luminosity, using the vertical and horizontal ranges at which the front (angle 0°) luminosity value becomes ½ the luminosity value as the half maximum angle.

### (Method for Evaluating Backlight Quality)

The lamp image (clarity of the CCFL) in the direct backlight was observed by eye from a point 30 cm away from the backlight.

Judgments were indicated using a “o” to indicate a quality at which no lamp image could be visually recognized, and an “x” when the image could be visually confirmed.

Table 2 shows the luminance and the vertical and horizontal direction luminosity half maximum angles, along with quality observation results. FIGS. 26 and 27 show viewing angle characteristics in the horizontal and vertical directions in Example 1 and Comparative Example 1.

In the method for laminating two prism sheets, it is clear that compared to the comparative examples, luminance and horizontal/vertical viewing angles are higher or equivalent. Quality (lamp image) in the overall screen size is also good, and uniformity is equivalent or better.

### BRIEF DESCRIPTION OF DRAWINGS

FIG. 1 A schematic cross sectional view of a light polarizing sheet in a first embodiment of the present invention.

FIG. 2 A schematic cross sectional view showing the FIG. 1 light polarizing sheet in use.

FIG. 3 A schematic cross sectional view of a light polarizing sheet in a second embodiment of the present invention.

FIG. 4 A view showing the cross prism sheet used in the light polarizing sheet of the second embodiment of the present invention.

FIG. 5 A view showing an alternative example cross prism sheet.

FIG. 6 A view showing alternative example cross prism sheet.

FIG. 7 A view showing an alternative example cross prism sheet with a cross-wrench shape.

FIG. 8 A view showing an alternative example cross prism sheet with a cross-wrench shape.

FIG. 9 A schematic cross-sectional view of a light polarizing sheet in a third embodiment of the present invention.

FIG. 10 A schematic cross-sectional view and perspective view of a light polarizing sheet in a fourth embodiment of the present invention.

FIG. 11 A schematic cross-sectional view of a light polarizing sheet in a fifth embodiment of the present invention.

FIG. 12 A view explaining the light path in a light polarizing sheet.

FIG. 13 A schematic cross-sectional view of a light polarizing sheet in a sixth embodiment of the present invention.

FIG. 14 A schematic cross-sectional view explaining the FIG. 13 light polarizing sheet in use.

FIG. 15 A schematic cross-sectional view of a light polarizing sheet in a seventh embodiment of the present invention.

FIG. 16 A schematic cross-sectional view of a light polarizing sheet in an eighth embodiment of the present invention.

FIG. 17 A schematic cross-sectional view of a light polarizing sheet in a ninth embodiment of the present invention.

FIG. 18 A schematic cross-sectional view of a light polarizing sheet in a tenth embodiment of the present invention.

FIG. 19 A view showing the pattern in which a touch-sensitive adhesive is disposed in the light polarizing sheet of the tenth embodiment of the present invention.

FIG. 20 A schematic cross-sectional view of a light polarizing sheet in an eleventh embodiment of the present invention.

FIG. 21 A schematic cross-sectional view of a light polarizing sheet in a twelfth embodiment of the present invention.

FIG. 22 A view showing a method for manufacturing the light polarizing sheet in the tenth embodiment the present invention.

FIG. 23 A view showing a method for manufacturing the light polarizing sheet in the tenth embodiment the present invention.

FIG. 24 A schematic cross-sectional view of the light polarizing sheet in an embodiment of the present invention.

FIG. 25 A schematic cross-sectional view of the backlight light source used to measure optical characteristics in embodiments of the present invention.

FIG. 26 A view showing viewing angle characteristics in the horizontal direction of the light polarizing sheet in an embodiment of the present invention.

FIG. 27 A view showing viewing angle characteristics in the vertical direction of the light polarizing sheet in an embodiment of the present invention.

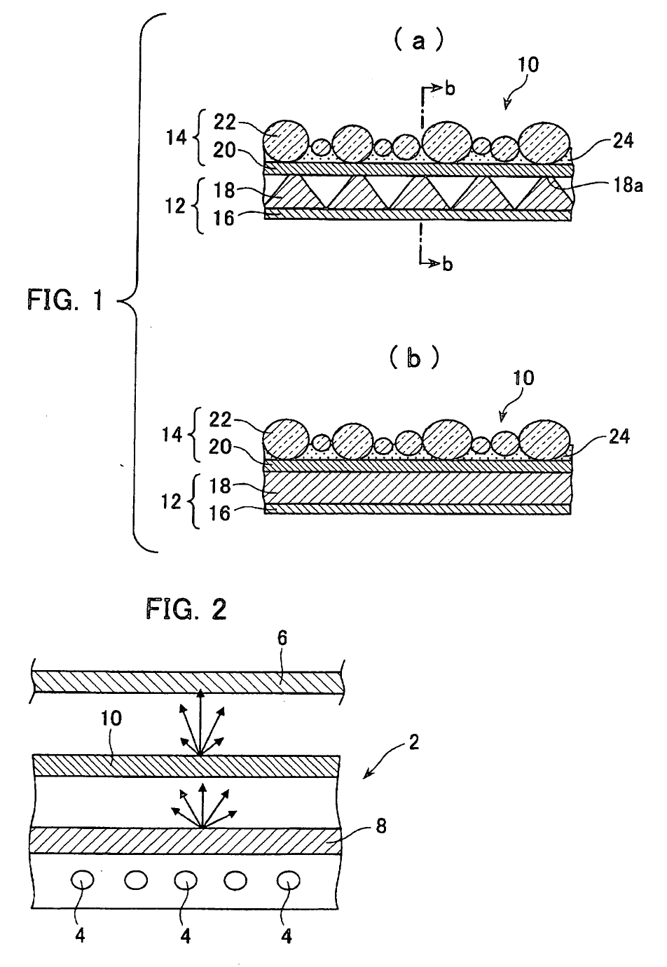

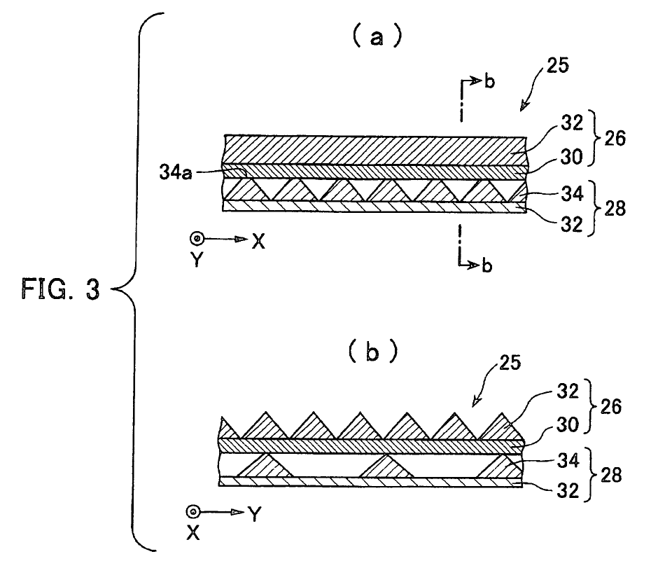

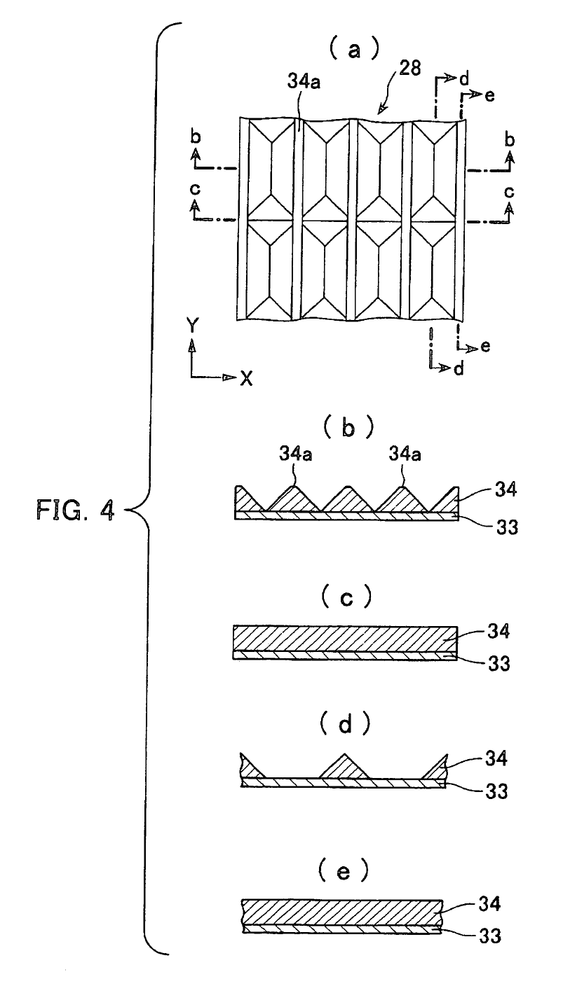

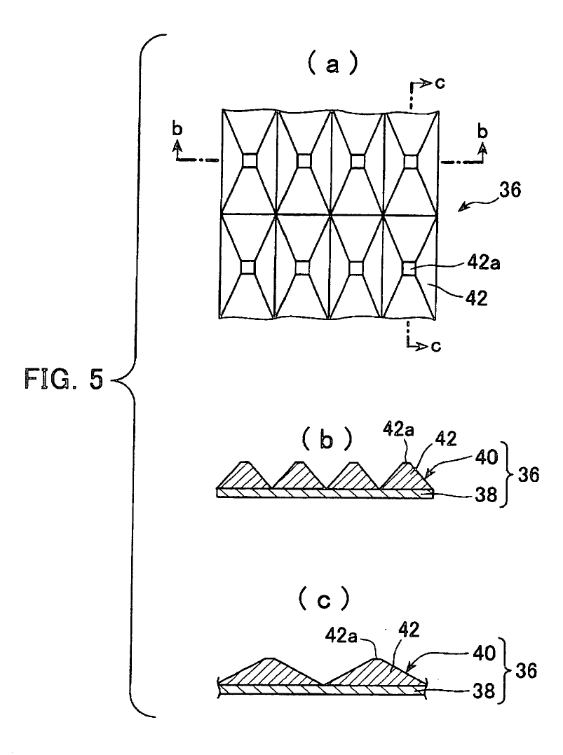

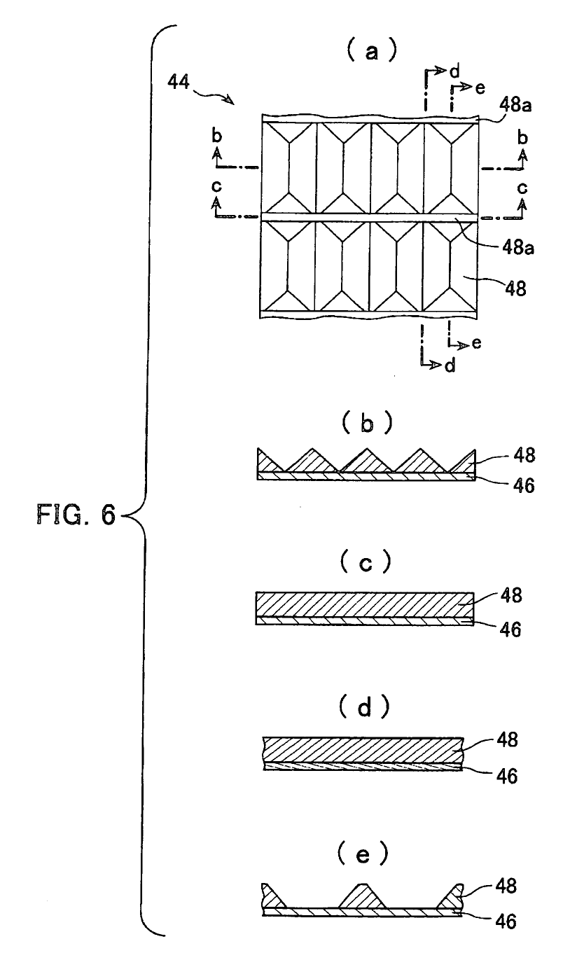

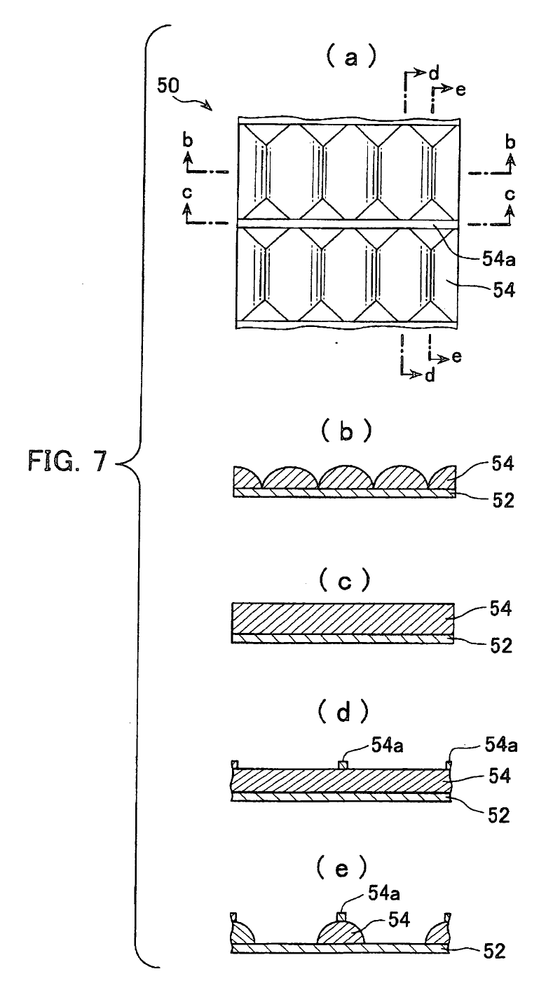

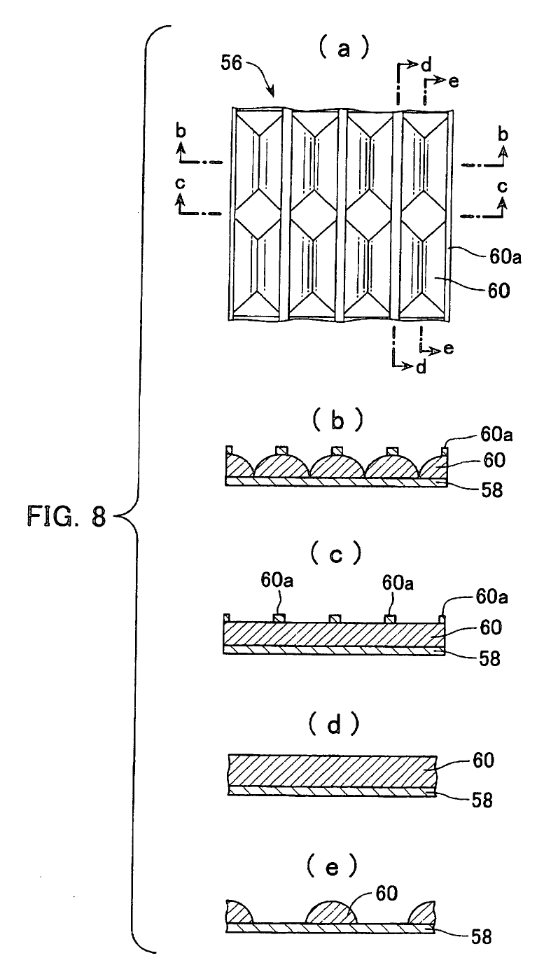

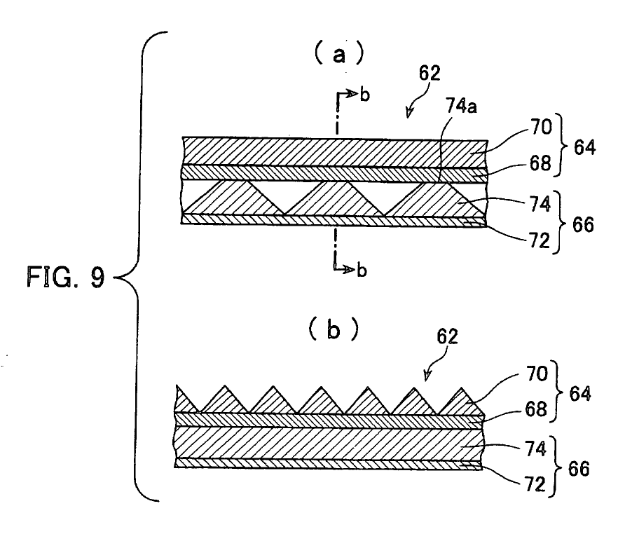

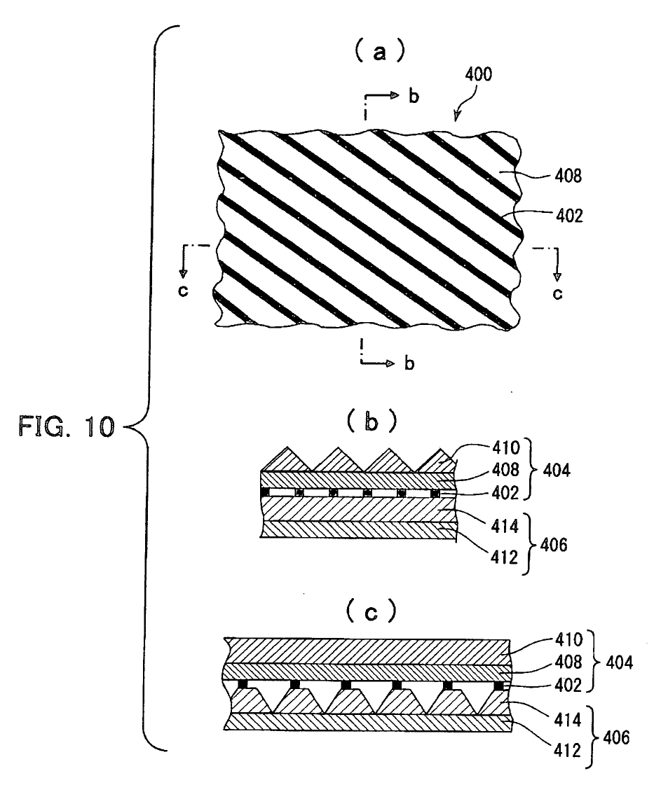

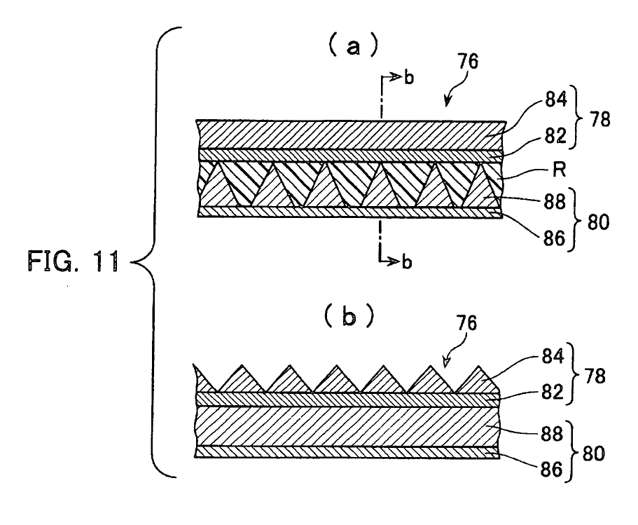

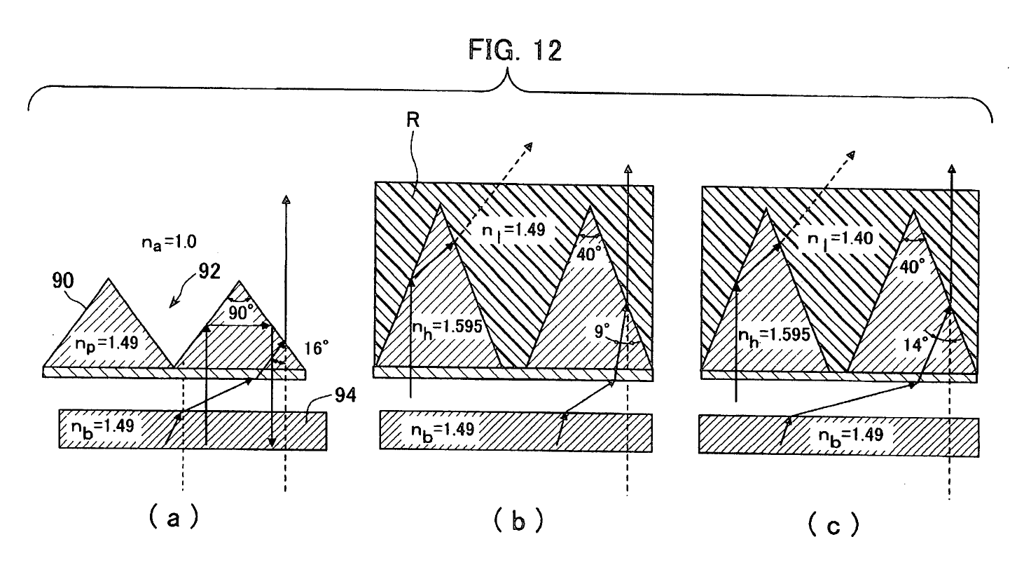

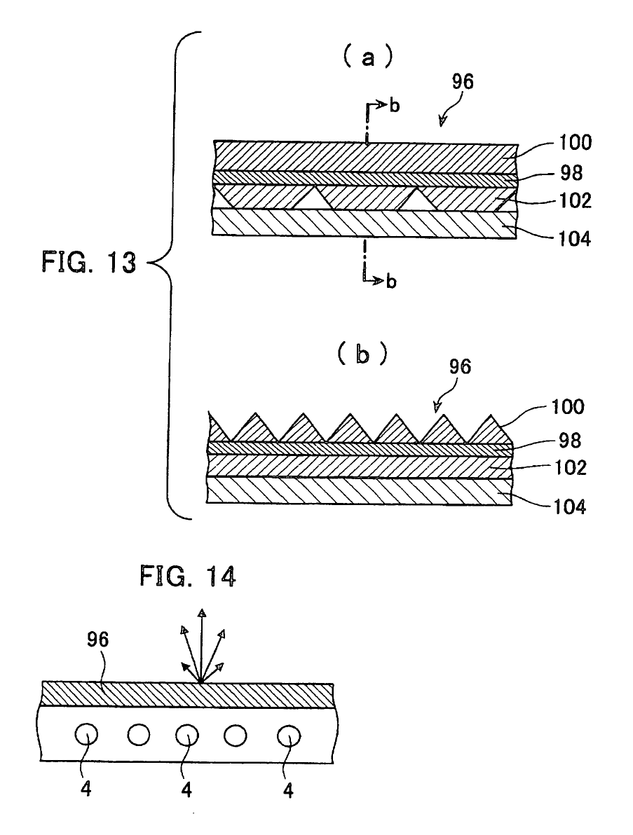

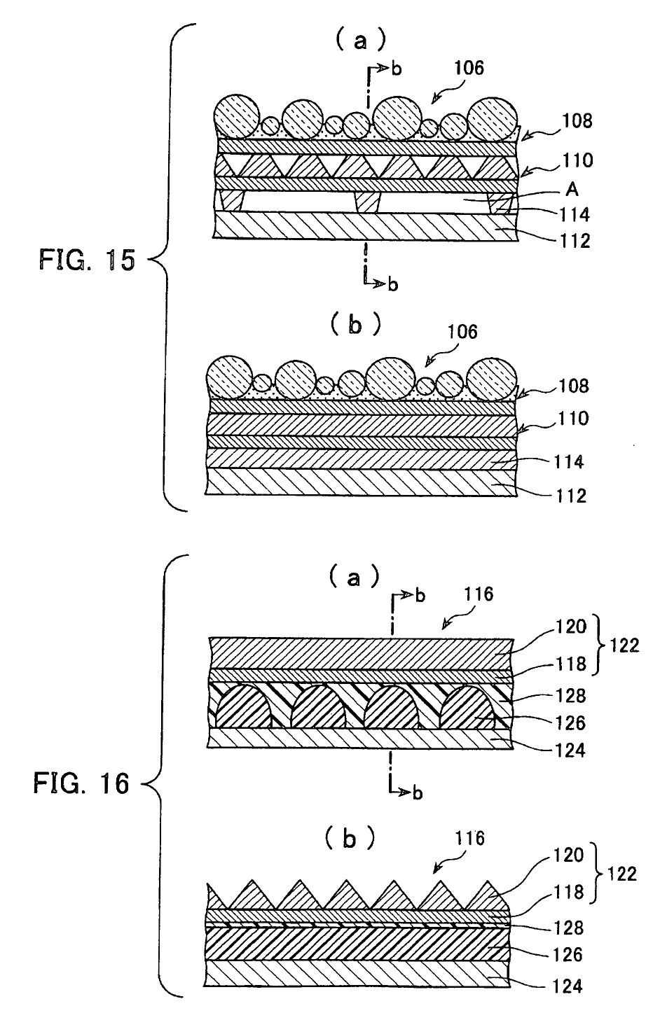

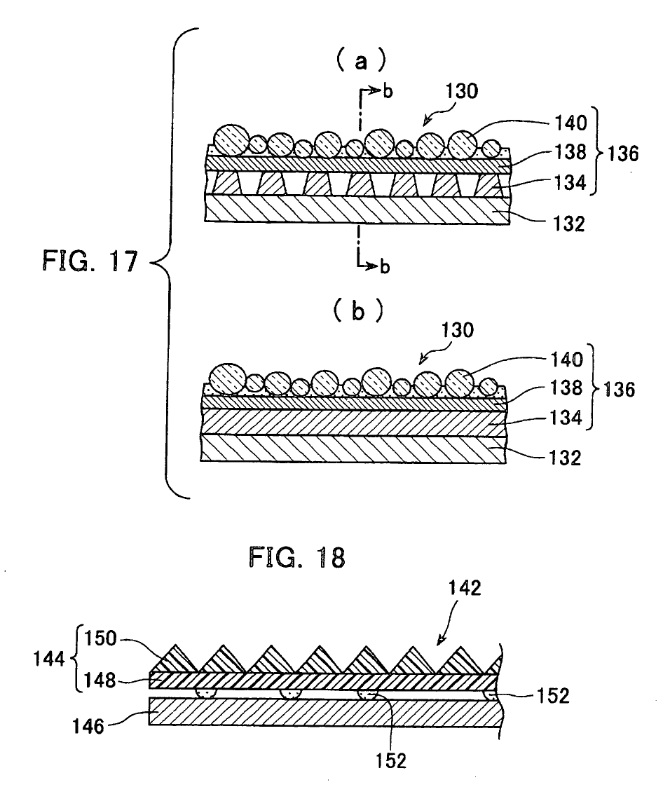

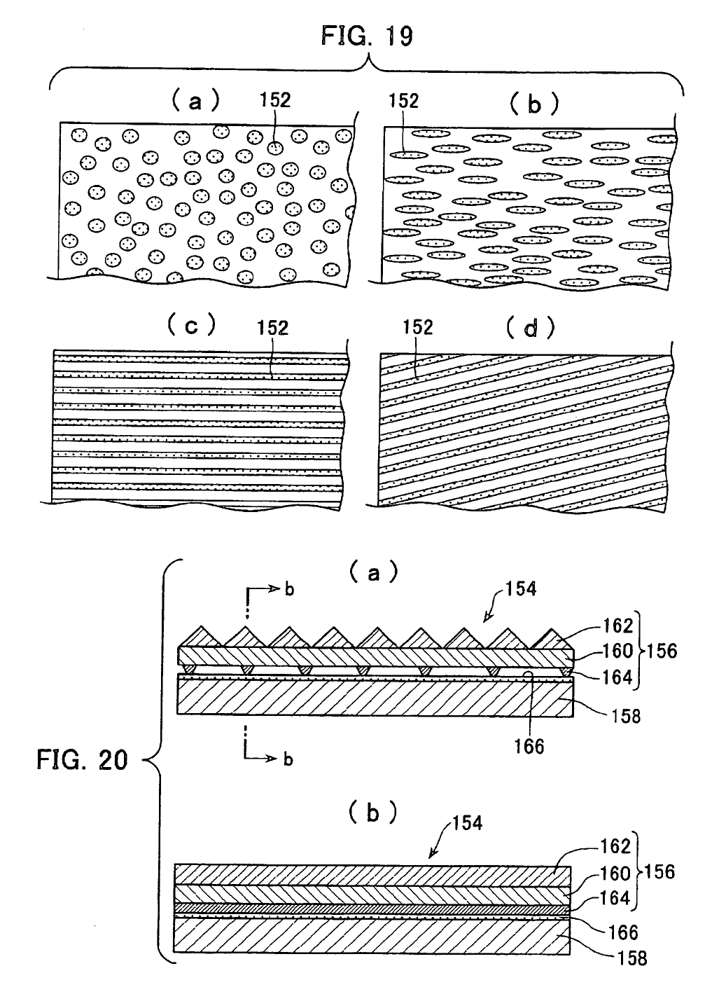

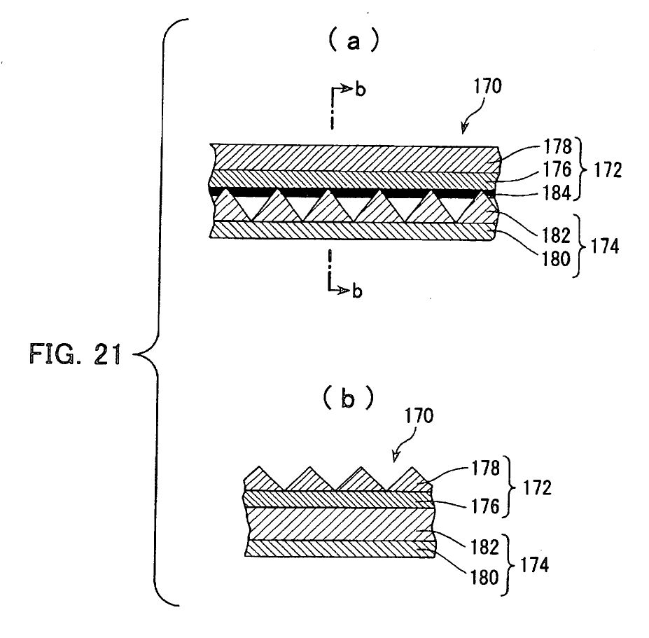

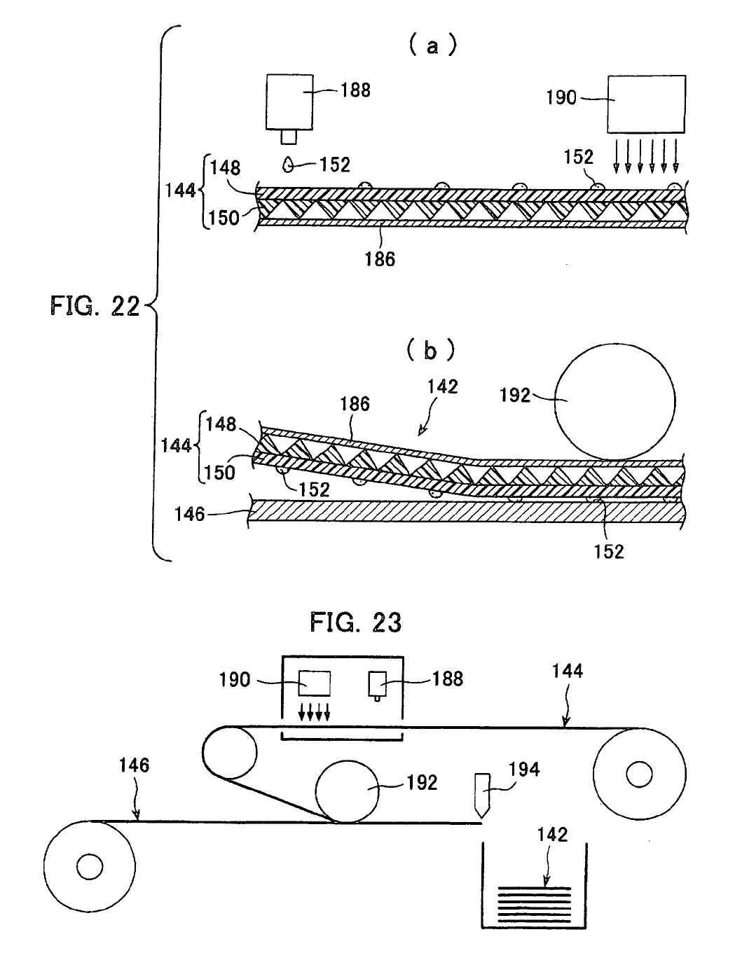

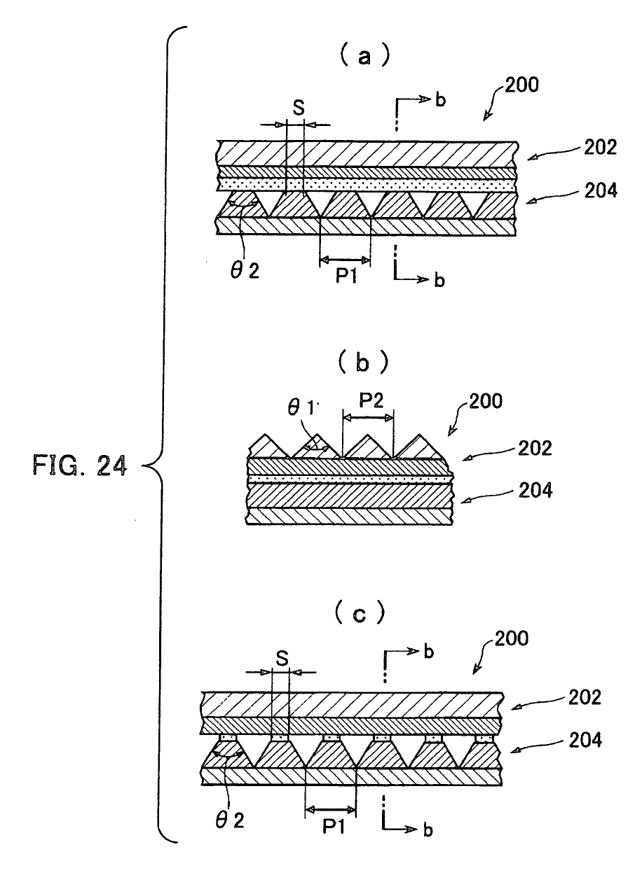

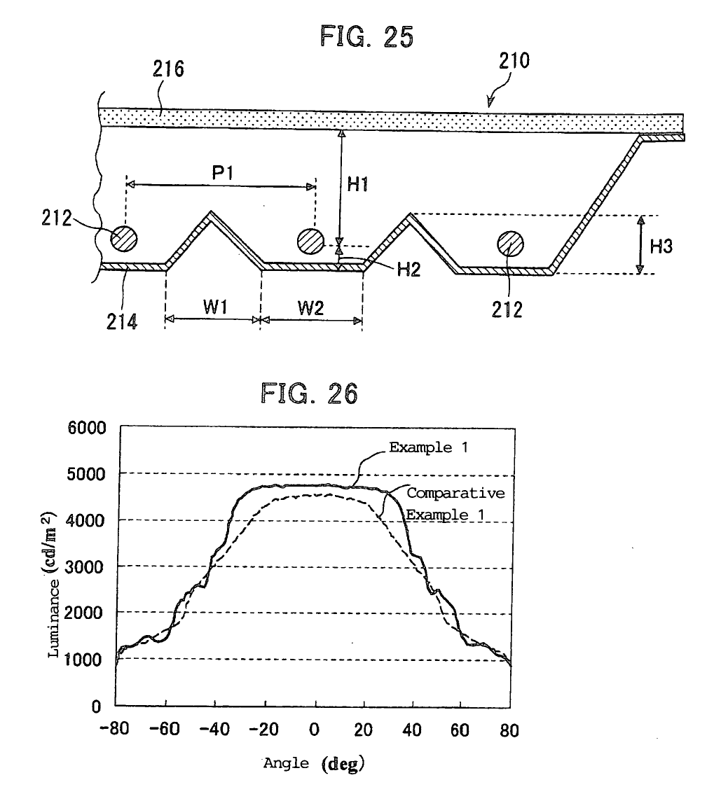

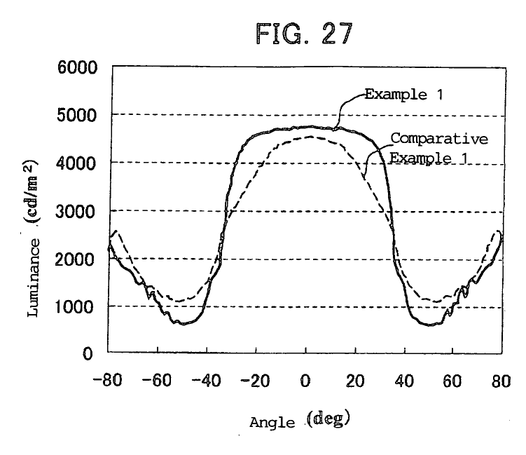

1. A light polarizing sheet comprising;
a first polarizing lens sheet including a sheet-shaped substrate and a first lens portion formed on one side of the substrate and
a second polarizing lens sheet including a sheet-shaped substrate and a second lens portion formed on one side of the substrate and having a flat portion on its tip;
wherein the flat portion on the second lens portion in the second polarizing lens sheet and the other side of the substrate of the first polarizing lens sheet are adhered using a transparent material.

2. The light polarizing sheet of claim 1, wherein the transparent material comprises an ionizing radiation curable resin which remains tacky after curing.

3. The light polarizing sheet of claim 1 or 2, wherein the transparent material is disposed on a portion of the flat portion.

4. A light polarizing sheet comprising;
a first polarizing lens sheet including a sheet-shaped substrate and a lens portion formed on one side of the substrate and
a second polarizing lens sheet including a sheet-shaped substrate and a lens portion formed on one side of the substrate;
wherein the first polarizing lens sheet is disposed such that the lens portion of the first polarizing lens sheet opposes the other side of the second polarizing lens sheet substrate, and an ionizing radiation curable resin or tacky particles are provided into a gap between the first and the second polarizing lens sheets.

5. The light polarizing sheet of claim 5, wherein the index of refraction of the ionizing radiation curable resin is set to be not less than 0.05 below the index of refraction of the second polarizing lens sheet.

6. A light polarizing sheet comprising;
a first polarizing lens sheet including a sheet-shaped substrate and a lens portion formed on one side of the substrate;
a diffusion sheet disposed facing to the other side of the light polarizing sheet and
a second lens portion made of plastic, disposed on the surface of the diffusion sheet opposing the light polarizing sheet;
whereby a resin with an index of refraction of not less than 0.05 greater than the resin forming the second lens portion is provided in between the other side of the substrate and the second lens portion.

7. The light polarizing sheet of claim 6, wherein the first lens portion comprises a plurality of columnar prisms, triangular in cross section and arrayed in parallel; the second lens portion comprises a plurality of columnar lenses, circular in cross section and arrayed in parallel; and the columnar lenses are disposed to extend at a right angle to the columnar prisms.

8. A light polarizing sheet comprising;
a polarizing lens sheet including a sheet-shaped substrate and a lens portion formed on one side of the substrate;
a protruding structure disposed such that one end thereof contacts another side of the substrate and
a diffusion sheet supported by the other end of the protruding structure so as to oppose the other side of the substrate.

9. The light polarizing sheet of claim 8, wherein the other end of the protruding structure is adhered to the diffusion sheet using transparent material.

10. The light polarizing sheet of any one of claims 1, 2, or 8, wherein the first lens portion is a columnar prism, triangular in section, wherein the peak angle of the columnar prism portion is not less than 60° and not greater than 150°.

11. The light polarizing sheet of any one of claims 1, 2, or 8, wherein the second lens portion is a columnar prism portion having the sectional shape of a truncated triangle, wherein the peak angle of the triangle is not less than 60° and not greater than 150°.

12. A light polarizing sheet comprising;
a polarizing lens sheet including a sheet-shaped substrate and a lens portion formed on one side of the substrate and
a diffusion sheet disposed facing to the other side of the substrate of the polarizing lens sheet;
whereby the diffusion sheet is disposed apart from the other side of the polarizing lens sheet using a transparent ionizing radiation curable resin portion discretely disposed between the other side of the polarizing lens sheet substrate and the diffusion sheet.

13. A light polarizing sheet comprising;
a first polarizing lens sheet including a sheet-shaped substrate and a first lens portion having triangular columnar prisms disposed in parallel to each other on one side of the substrate and
a second polarizing lens sheet including a sheet-shaped substrate and a second lens portion having triangular columnar prisms disposed in parallel to each other on one side of the substrate;
whereby the first polarizing lens sheet and the second polarizing lens sheet are disposed such that the first lens portion extends perpendicular to the second lens portion and, by burying the tip of the first polarizing lens sheet first lens portion, the first polarizing lens sheet and the second polarizing lens sheet are integrated into a single piece, with a transparent material tacky layer provided on a side opposite the second polarizing lens sheet substrate second lens portion,
such that if X is the peak angle of the lens portion controlling the horizontal viewing direction within the first lens portion and the second lens portion, and Y is the peak angle of the lens portion controlling the vertical viewing direction within the first lens portion and the second lens portion, Formulas (1) through (3) below are satisfied:
70°≦X≦150° Formula (1)
70°≦Y≦130° Formula (2)
195°≦X+Y≦225° Formula (3)

14. A method for manufacturing a light polarizing sheet comprising steps of
forming a tacky layer by transparent material on the other side of a first polarizing lens sheet substrate, on the flat portion of a second polarizing lens sheet second lens portion, or on the other side of the first polarizing lens sheet substrate and the flat portion of the second lens portion on the second polarizing lens sheet;
and adhered the flat portion of the second lens portion of the second polarizing lens sheet to the other side of the substrate of the first polarizing lens sheet.

15. A method for manufacturing a light polarizing sheet including a polarizing lens sheet having a sheet-shaped substrate and a first lens portion formed on one side of the substrate, a protuberance structure linked at one end to the other side of the substrate, and a diffusion sheet supported on the other end of the protuberance structure and disposed so as to face to the other side of the substrate, the method comprising the steps of
forming at the other end of the protuberance structure a transparent material tacky layer which retains tackiness after curing and
pressing the diffusion sheet onto the other end of the protuberance structure and adhering the polarizing lens sheet and the diffusion sheet.

16. A method for manufacturing a light polarizing sheet including a diffusion sheet and a polarizing lens sheet having a sheet-shaped substrate and a lens portion formed on one side of the substrate, the method comprising steps of;
coating a transparent material which retains tackiness after curing onto the other side of the substrate of the polarizing lens sheet in a dotted or striped pattern and
superimposing the other side of the polarizing lens sheet substrate and one side of the diffusion sheet to adhere together the polarizing lens sheet and the diffusion sheet.
